(19) United States
(12) Patent Application Publication
(10) Pub. No.: US 2022/0207543 A1
(43) Pub. Date: Jun. 30, 2022

(54) METHODS AND APPARATUS TO DEDUPLICATE AUDIENCES ACROSS MEDIA PLATFORMS

(71) Applicant: The Nielsen Company (US), LLC, New York, NY (US)

(72) Inventors: Dipti Umesh Shah, Pleasanton, CA (US); Joshua Ivan Friedman, Miami, FL (US); Edward Murphy, North Stonington, CT (US); Tushar Chandra, Chicago, IL (US); Neel Parekh, Sunnyvale, CA (US); Evan A. Brydon, San Francisco, CA (US); Scott J. Sereday, Rochelle Park, NJ (US); Billie J. Kline, Inverness, FL (US)

(21) Appl. No.: 17/565,287

(22) Filed: Dec. 29, 2021

Related U.S. Application Data
(60) Provisional application No. 63/132,367, filed on Dec. 30, 2020.

(51) Int. Cl. G06Q 30/02; G06N 7/00

(52) U.S. Cl. CPC G06Q 30/0204; G06N 7/005; G06Q 30/0203

(57) ABSTRACT

Methods, apparatus, and articles of manufacture to deduplicate audiences across media platforms are disclosed. An example apparatus includes memory; and processor circuitry to execute the instructions to: generate a match panel by matching panelists with database proprietor accounts based on matching information; generate respondent-level data from the match panel by combining first media exposure data corresponding to panelists associated with the match panel and second media exposure data corresponding to the database proprietor accounts associated with the match panel, the first and second media exposure data corresponding to a media item; determine a probability distribution corresponding to observed deduplication audience size data, the observed deduplication audience size data based on the respondent-level data of the match panel; perform iterative proportional fitting on an output probability corresponding to the probability distribution; and determine a deduplicated total audience size for the media item based on a result of the iterative proportional fitting.

### RELATED APPLICATION

This patent claims the benefit of U.S. Provisional Patent Application No. 63/132,367, which was filed on Dec. 30, 2020. U.S. Provisional Patent Application No. 63/132,367 is hereby incorporated herein by reference in its entirety. Priority to U.S. Provisional Patent Application No. 63/132,367 is hereby claimed.

### FIELD OF THE DISCLOSURE

This disclosure relates generally to computer-based media monitoring, and, more particularly, to methods and apparatus to deduplicate audiences across media platforms.

### BACKGROUND

Structuring computer system to determine sizes and demographics of audiences of media presentations helps media providers and distributors schedule programming and determine prices for advertising presented during the programming. In addition, accurate estimates of audience demographics enable advertisers to target advertisements to certain types and sizes of audiences. To collect these demographics, an audience measurement entity enlists a group of media consumers (often called panelists) to cooperate in an audience measurement study (often called a panel) for a predefined length of time. In some examples, the audience measurement entity obtains (e.g., directly, or indirectly from a media service provider) return path data from media presentation devices (e.g., set-top boxes) that identifies tuning data from the media presentation device. In such examples, because the return path data may not be associated with a known panelist, the audience measurement entity models and/or assigns viewers to represent the return path data. Additionally, the media consumption habits and demographic data associated with the enlisted media consumers are collected and used to statistically determine the size and demographics of the entire audience of the media presentation. In some examples, this collected data (e.g., data collected via measurement devices) may be supplemented with survey information, for example, recorded manually by the presentation audience members.

### BRIEF DESCRIPTION OF THE DRAWINGS

FIG. 1 is a block diagram of an example environment including media deduplication circuitry to deduplicate audience totals across different combinations of platforms.

FIG. 2 is a block diagram of an example implementation of the media deduplication circuitry of FIG. 1.

FIGS. 3-8 are flowcharts illustrating example machine readable instructions that may be executed to implement the example media deduplication circuitry of FIGS. 1 and/or 2.

FIGS. 9A-9D illustrate example data used to illustrate observed deduplication based on respondent-level data.

FIGS. 10A and 10B illustrate example pre-Iterative Proportional Fitting (IPF) capping rules.

FIG. 11 illustrates an example three-dimensional table corresponding to a weighted match panel.

FIG. 12 is a block diagram of an example processing platform including processor circuitry structured to execute the example machine readable instructions and/or the example operations of FIGS. 3-8 to implement the example media deduplication circuitry of FIGS. 1 and/or 2.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 3-8 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Techniques for monitoring user access to an Internet-accessible media, such as digital television (DTV) media, digital advertisements via desktop computers and mobile devices (e.g., digital advertisement measurement (DAM)), and digital content have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietors to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client to thereby identify the client based on the internal records of the database proprietor. In the event the client device corresponds to a subscriber of the database proprietor, the database proprietor logs/records a database proprietor demographic impression in association with the user/client device.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or advertisement campaign) has been accessed by a web population or audience members (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, digital TV (DTV) media temporarily available online after broadcast, TV media, etc.). For example, a user may start watching a particular television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process that is necessary to adjust cross-platform media exposure totals by reducing (e.g., eliminating) the double counting of individual audience members that were exposed to media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. As used herein, an audience size is a quantity of unique audience members of particular events (e.g., exposed to particular media, etc.). That is, an audience size is a number of deduplicated or unique audience members exposed to a media item of interest of audience metrics analysis. A deduplicated or unique audience member is one that is counted only once as part of an audience size. Thus, regardless of whether a particular person is detected as accessing a media item once or multiple times, that person is only counted once as the audience size for that media item. In this manner, impression performance for particular media is not disproportionately represented when a small subset of one or more audience members is exposed to the same media an excessively large number of times while a larger number of audience members is exposed fewer times or not at all to that same media. Audience size may also be referred to as unique audience or deduplicated audience. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

An AME may want to find unique audience/deduplicate impressions across multiple database proprietors, custom date ranges, custom combinations of assets and platforms, etc. Some deduplication techniques perform deduplication across database proprietors using particular systems (e.g., Nielsen's TV Panel Audience Link). For example, such deduplication techniques match or probabilistically link personally identifiable information (PII) from each source. Such deduplication techniques require storing massive amounts of user data or calculating audience overlap for all possible combinations, neither of which are desirable. PII data can be used to represent and/or access audience demographics (e.g., geographic locations, ages, genders, etc.).

In some situations, while the database proprietors may be interested in collaborating with an AME, the database proprietor may not want to share the PII data associated with its subscribers to maintain the privacy of the subscribers. One solution to the concerns for privacy leverages third-party cookies. Notably, although third-party cookies are useful for third-party measurement entities in many of the above-described techniques to track media accesses and to leverage demographic information from third-party database proprietors, use of third-party cookies may be limited or may cease in some or all online markets. That is, use of third-party cookies enables sharing anonymous subscriber information (without revealing personally identifiable information (PII)) across entities which can be used to identify and deduplicate audience members across database proprietor impression data. However, to reduce or eliminate the possibility of revealing user identities outside database proprietors by such anonymous data sharing across entities, some websites, internet domains, and/or web browsers will stop (or have already stopped) supporting third-party cookies. This will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data will not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

Some industries are moving away from cookies and/or other media tagging techniques to increase privacy and/or security. As such, audience measurement entities may utilize a database proprietor (e.g., a data enrichment provider (DEP)) to perform audience measurements while adhering to privacy and/or security guidelines. Examples disclosed herein onboard media publishers as a database proprietor for audience measurement by (a) determining a PII-match between panelists and database proprietor accounts using a secure environment, (b) obtain digital ad exposure information for the matched panelists from the database proprietor, and (c) determine deduplicated audience sizes across media platforms (e.g., television and digital audiences) using a Bayesian inference technique. Examples disclosed herein increase the reliability that total advertisement measures (TAM) are able to provide at granular levels.

Total advertisements measures (TAM) may be used to measure audience data corresponding to an advertisement campaign of relevant size for media across multiple types of media delivery platforms (e.g., television and online advertisements). For example, in examples disclosed herein, a total audience size is an audience size for media delivered on a television network platform and online Internet platforms (e.g., desktop, computers, mobile devices, etc.). To enable TAR, examples disclosed herein utilize digital ad ratings, television audience measurement information, and people meter match panel information from an audience measurement entity. As further described below, a people meter is a device that monitors a panelists exposure to media by obtaining ambient audio. Examples disclosed herein utilize panel meter panel information for measuring duplicate audience measurements. Because panel meter information can provide measurement across different platforms (e.g., television, desktop, mobile, etc.). Accordingly, cross-platform duplication measurement is based on observation of exposure of online and television advertisements from panelists. To expand the capabilities of a panel, information from data provider (e.g., database proprietors) can be leveraged to march data provider information with panel information to generate a match panel. Although some examples disclosed herein refer to advertisements, examples disclosed herein can be similarly applied to any media (e.g., advertisements and content).

Examples disclosed herein determine a PII-match between panelists and database proprietor accounts using various combinations of PII variables (e.g., last name, first name, street address, city, state, zip code, phone number, email address, date of birth year, date of birth month, etc.). The audience measurement entity provides a secure panelist identifier for each panelist entered into the match. The database proprietor provides an encrypted ID that will be static for a given iteration. Examples disclosed herein use match logic to ensure a 1:1 match between the panelist and the database proprietor account.

Given the bias that may exist in data providers' accounts and bias introduced by a match, examples disclosed herein utilize unification, in-tab rules, and panel weighting to align the match panel demographics with the demographics of the people meter panel to ensure a representative sample. After the panelists are matched to database proprietor accounts, examples disclosed herein use the matched data to determine deduplicated audience sizes (e.g., deduplicated total audience sizes) across media platforms (e.g., television and digital audiences) using a Bayesian inference technique. The Bayesian inference techniques result in probability distributions for total audience exposure across different combinations of platforms (e.g., television only, television and mobile only, mobile and desktop only, etc.) that result in more accurate total audience estimations across the different combinations of platforms than previous simple weighting techniques. Additionally, examples disclosed herein utilize iterative proportional fitting (IPF) to update measurements from the match panel with information from digital advertisement measurement and people meter television measurement. Additionally, examples disclosed herein pre-IPF smoothing, post-IPF and/or post-IPF capping to align the Bayesian outputs with DAR constraints.

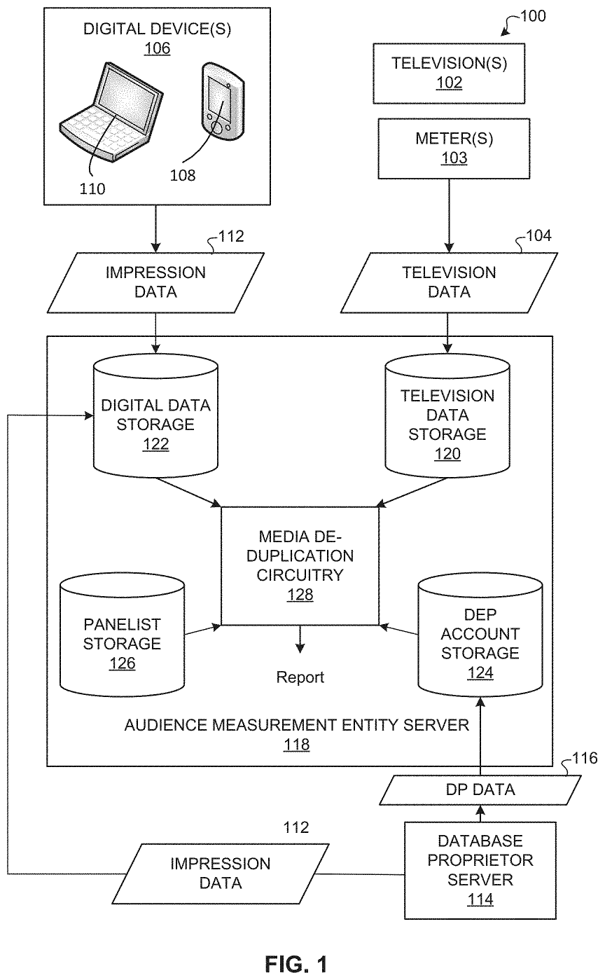

FIG. 1 illustrates an example environment 100 for obtaining data from panelists and a database proprietor and determining a total deduplicated audience across different combinations of platforms. The example environment 100 includes example televisions(s) 102, example meter(s) 103, example television data 104, example digital device(s) 106 (e.g., including example mobile devices 108 and example desktops 110), example impression data 112, an example database proprietor (DP) server 114, example DP data 116, example television data storage 120, example digital data storage 122, example (DEP) account storage 124, example panelist storage 126, and example media deduplication circuitry 128.

The example television(s) 102 of FIG. 1 correspond to televisions of panelists that are monitored. The television(s) 102 may include a meter and/or the audio of the television may be intercepted by the example meter 103 (e.g., a personal people meter (PPM), a local people meter (LPM), etc.) of a panelist to generate signatures and/or extract codes from the audio output by the television(s) 102. Accordingly, the television(s) 102 and/or meters that obtain audio from the television(s) 102 can provide (e.g., via a wired and/or wireless network communication) the example television data 104 to the example audience measurement entity server 118 to credit exposure to media via the television(s) 102. The example television data 104 includes the media presentation data (e.g., data related to media presented while the television 102 is on and a user is present). The example television data 104 may further include a household identification, a tuner key, a presentation start time, a presentation end time, a channel key, etc.

Although the illustrated example illustrates the example audience measurement entity server 118 of FIG. 1 collecting the example television data 104 from one meter and/or television 102 at one location, the example audience measurement entity server 118 may collect television data from any number or type of meters at any number of locations. The example meter 103 may be implemented in connection with additional and/or alternative types of media presentation devices, such as, for example, a radio, a computer monitor, a video game console, and/or any other device capable to present media to a user. The example meter 103 may be a portable people meter, a cell phone, a computing device, a sensor, and/or any other device capable of metering (e.g., monitoring) user exposure to media.

In some examples, the example meter 103 of FIG. 1 may include a set of buttons assigned to audience members to determine which of the audience members is watching the example televisions 102. The example meter 103 may periodically prompt the audience members via a set of LEDs, a display screen, and/or an audible tone, to request confirmation that the audience member is present at a first media presentation location by pressing an assigned button. In some examples, to decrease the number of prompts and, thus, the number of intrusions imposed upon the media consumption experience of the audience members, the example meter 103 prompts only when unidentified audience members are located at the first media presentation location and/or only after the example meter 103 detects a channel change and/or a change in state of the television(s) 102. In other examples, the meter 103 may include at least one sensor (e.g., a camera, 3-dimensional sensor, etc.) and/or be communicatively coupled to at least one sensor that detects a presence of the user in a first example media presentation location.

The example digital device(s) 106 of FIG. 1 include(s) mobile devices 108 and desktops 110. Additionally or alternatively, other platforms may be included in the digital device(s) 106. The digital device(s) 106 report(s) the impression data 112 (also referred to as impression requests) for Internet-based media to the example AME server 118. The impression data 112 of the illustrated example includes information about accesses to the media on the digital device(s) 106. In some examples, the digital device(s) 106 include(s) cookies, tags (e.g., ID3 tags, CMS tags, etc.), and/or any other media monitoring software to generate the impression requests associated with media when the media has been accessed. In some examples, the digital device(s) 106 include(s) CMS or ID3 tags to generate the impression requests. Such impression data 112 allows monitoring entities, such as the AME server 118, to collect a number of media impressions for different media accessed via digital device(s) 106 (e.g., representing a total digital audience). By logging media impressions, the AME server 118 can generate a unique audience and/or an impression count for different desktop and mobile media. The example impression data 112 may include cookie and/or tag identifiers to identify which digital device(s) 106 is/are associated with impression requests.

In some examples, execution of the beacon instructions corresponding to the media causes the digital devices 106 to send impression requests to the database proprietor server 114 (e.g., accessible via an Internet protocol (IP) address or uniform resource locator (URL)). In some examples, the beacon instructions cause the digital devices 106 to locate device and/or user identifiers and media identifiers in the digital devices 106. The device/user identifier may be any identifier used to associate demographic information with a user or users of the digital devices 106. Example device/user identifiers include cookies, hardware identifiers (e.g., an international mobile equipment identity (IMEI), a mobile equipment identifier (MEID), a media access control (MAC) address, etc.), an app store identifier (e.g., a Google Android ID, an Apple ID, an Amazon ID, etc.), an open source unique device identifier (OpenUDID), an open device identification number (ODIN), a login identifier (e.g., a username), an email address, user agent data (e.g., application type, operating system, software vendor, software revision, etc.), an Ad ID (e.g., an advertising ID introduced by Apple, Inc. for uniquely identifying mobile devices for purposes of serving advertising to such mobile devices), third-party service identifiers (e.g., advertising service identifiers, device usage analytics service identifiers, demographics collection service identifiers), etc. In some examples, fewer or more device/user identifier(s) may be used. The media identifiers (e.g., embedded identifiers, embedded codes, embedded information, signatures, etc.) enable the AME server 118 and/or DP server 114 can identify to media objects accessed via the digital devices 106. The impression data of the illustrated example causes the AME 118 and/or the database proprietor server 114 to log impressions for the media. As described above, an impression request is a reporting to the AME server 118 and/or the database proprietor server 114 of an occurrence of the media being presented at the digital devices 106. The impression requests of the impression data 112 may be implemented as a hypertext transfer protocol (HTTP) request. However, whereas a transmitted HTTP request identifies a webpage or other resource to be downloaded, the impression requests include audience measurement information (e.g., media identifiers and device/user identifier) as its payload. The server 114, 118 to which the impression requests are directed is programmed to log the audience measurement information of the impression requests as an impression (e.g., a media impression such as advertisement and/or content impressions depending on the nature of the media accessed via the digital devices 106). In some examples, the database proprietor server 114 transmits the impression data 112, including logged impressions to the audience measurement entity server 118.

The example database proprietor server 114 of FIG. 1 (e.g., also referred to as a DEP server or a data provider server) maintains user account records corresponding to users registered for services (such as Internet-based services) provided by the database proprietors. That is, in exchange for the provision of services, subscribers register with the database proprietor. Such services may be email services, social networking services, news media services, cloud storage services, streaming music services, streaming video services, online retail shopping services, credit monitoring services, etc. Example database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, etc.), and/or any other site that maintains user registration records. As part of this registration, the subscribers provide detailed demographic information to the database proprietor server 114. Demographic information may include, for example, gender, age, ethnicity, income, home location, education level, occupation, etc. In the illustrated example, the database proprietor server 114 sets a device/user identifier on a subscriber's digital devices 106 that enables the database proprietor server 114 to identify the subscriber. In the illustrated example, the example database proprietor server 114 may be one of many database proprietors that operate on the Internet to provide services to subscribers. The database proprietor server 114 transmits the example DP data 116 to the example audience measurement entity server 118. The DP data 116 is anonymized data to protect the identity of the users of services provided by the database proprietor. The DP data 116 may include information related to DEP accounts of users including one or more of a last name, a first name, a street address, a city, a state, a zip code, a phone number, an email address, a date of birth year, a date of birth month, etc.

In the illustrated example, the example AME server 118 does not provide the media to the digital device(s) 106 and/or the television(s) 102 and is a trusted (e.g., neutral) third party (e.g., The Nielsen Company, LLC) for providing accurate media access (e.g., exposure) statistics. The AME server 118 monitors exposure to media via the digital device(s) 106 and/or the television(s) 102. The AME server 118 then monitors those client devices (e.g., the digital device(s) 106 and/or the television(s) 102) to determine media (e.g., Internet television programs, Internet radio programs, movies, advertisements, streaming media, web sites, etc.) presented to those panel members the digital device(s) 106 and/or the television(s) 102. In this manner, the AME server 118 can determine exposure metrics for different media based on the collected media measurement data. In some examples, the impression requests and/or the impression logs of the impression data 112 are logged by the AME server 118 in response to impression requests from the digital device(s) 106 that requested the media. The example AME server 118 monitors exposure to media based on the impression requests, the impression logs, and/or other monitoring techniques. The example AME server 118 includes the example storages 120, 122, 124, 126 and the example media-deduplication circuitry 128.

The example television data storage 120 of FIG. 1 stores the television data 104 from the television(s) 102 and/or meter(s) 103 associated with the panel. In some examples, the television data has been processed by one or more processors (e.g., located locally or remotely) to determine one or more reaches of television media. In such examples, the television data includes the determined reach value(s). The example digital data storage 122 stores the impression data 112 related to media exposure via the digital device(s) 106 (e.g., corresponding to logged impressions (directly from digital devices of panelists and/or from the database proprietor server 114). In some examples, the impression data has been processed by one or more processors (e.g., located locally or remotely) to determine one or more reaches of the digital media. In such examples, the digital data includes the determined reach value(s). The example DEP account storage 124 stores DP data 116 (e.g., identification information, demographic information, etc.) related to the accounts of users corresponding to the database proprietor server 114. The example panelist storage 126 stores information (e.g., identification information, demographic information, etc.) related to the panelists of the panel.

The example media deduplication circuitry 128 of FIG. 1 obtains the counts of impression logs via the digital data storage 122, counts of exposure data from panelists via the television data storage 120, panelist information via the panelist storage 126, and DEP account information via the DEP account storage 124. Because the digital storage 122 may have impression counts related to exposure to media that may not be captured via the metering equipment of the panel, the example deduplication circuitry 128 generates a match panel by matching a panelist to a DEP account using PII information. After the match panel is generated, the deduplication circuitry 128 will have media exposure information across different media delivery platforms (e.g., television, desktop, mobile). In this manner, the example media deduplication circuitry 128 can determine deduplication information for media. For example, if a panelist was exposed to media via mobile and television, traditional techniques may determine that two people were exposed to the media when one person was exposed to the media across two platforms. Accordingly, the example media deduplication circuitry 128 can leverage the information from matched panelists to determine deduplication media exposure totals (e.g., reach). During a campaign, the panel may change. For example, matching may occur every week of a campaign so that the panelists in the match panel change every week throughout the campaign, thereby ensuring an accurate panel match over time.

After the example media deduplication circuitry 128 of FIG. 1 generates the match panel, the example media deduplication circuitry 128 generates respondent-level data for the different platforms (e.g., desktop, mobile, and television) using the match panel. For example, the media deduplication circuitry 128 may combine the respondent-level data from impression data in the digital data storage 122 associated with a DEP account with the television exposure data from a matched panelist from the television data storage 120. As used herein, respondent-level data refers to processed viewing data at the level of individual respondents. Respondent level data may include complete time records across each broadcasting day of all viewing sessions by every family member and guest on all metered media output devices in a home including the demographic data. The combination of information corresponds to respondent-level data related to which panelists saw ads across the different platforms. To represent a universe of users, the media deduplication circuitry 128 applies unification rules (e.g., to remove panelists that are out-of-tab more than a threshold amount of time) and/or weights match panelists (e.g., to match to the universe of users) periodically, aperiodically, and/or based on a trigger. As used herein, out-of-tab represents when metering information is not obtained at the AME server 118 (e.g., because the meter of a panelist does not have a network connection, the meter is not functional, the panelist has turned the meter off, etc.) at a predetermined time. For example, during a 15-week campaign, the match panel may be unified and/or weighted every week, thereby resulting in a dynamic match panel that accurately matches the universe over time.

After the respondent-level data is determined for the match panelists of the match panel, the example media deduplication circuitry 128 of FIG. 1 determines one or more probability distributions that correspond to the observed deduplication across different combinations of platforms (e.g., media exposure to television only; television and mobile only; television, mobile, and desktop; etc.) using a Bayesian inference model. The use of the Bayesian inference model provides variability to the panel data to better correspond to universe estimates. For example, a panel may identify 1% exposure to media, while the real-world exposure may be 2% or 3%. Accordingly, using a Bayesian inference model helps to overcome biases, limited scope, and/or other variability of the match panel. The example media deduplication circuitry 128 may sample the probability distributions of the different combinations of platforms to generate output probabilities of exposure (e.g., deduplicated exposure) to media. For example, the media deduplication circuitry 128 may apply observed data to a graphical model. The graphical model can accept or reject the samples so that the results is consistent with the probability distributions.

In some examples, the media deduplication circuitry 128 may infer probabilities across demographic(s) using a multilevel model with a hierarchical prior probability distribution (e.g., also referred to as a prior). The multilevel model with a hierarchical prior generates an exposure probability across platform combinations for every age and/or gender combination. In some examples, the media deduplication circuitry 128 multiplies the output probabilities by a universe estimate (UE) and then compares the results to the constrains to make sure the outputs are consistent with the constraints. For example, a constraint may be that the total deduplicated audience for television and mobile should not be larger than the total audience for television or mobile.

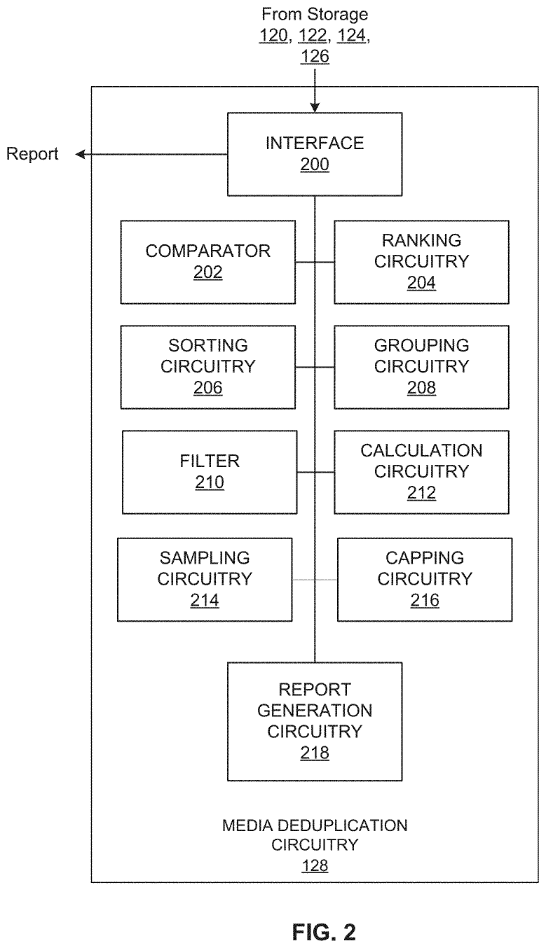

In some examples, the panel and the DAM information corresponding to the database proprietor 114 offer measurements of television and digital ad performance based on a larger sample size than the people meter match panel. Accordingly, the media deduplication circuitry 128 may perform iterative proportional fitting (IPF) to allow for observed audience duplication rates to be adjusted according to the information provided by TV and DAR reaches. The resulting deduplication audience reflects both observed duplication from the match panel as well as the industry standard television, desktop, and mobile campaign reach produced by the people meter panel and the DAR reporting. In some examples, the media deduplication circuitry 128 may apply pre-IPF and/or post-IPF smoothing and/or capping logic to an error during the IPF procedure (e.g., to avoid percentages at 0% (which may result in a divide by zero during the IPF) or above 100% (which statistically do not make sense)). The example media deduplication circuitry 128 is further described below in conjunction with FIG. 2.

FIG. 2 is a block diagram of the example media deduplication circuitry 128 to generate a report corresponding to deduplicated audience totals for a media item corresponding to a media campaign across different platform combinations. The example media deduplication circuitry 128 of FIG. 2 may be instantiated (e.g., creating an instance of, bring into being for any length of time, materialize, implement, etc.) by processor circuitry such as a central processor unit executing instructions. Additionally or alternatively, the example media deduplication circuitry 128 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor. The example media deduplication circuitry 128 includes an example interface 200, an example comparator 202, example ranking circuitry 204, example sorting circuitry 206, example grouping circuitry 208, an example filter 210, example calculation circuitry 212, example sampling circuitry 214, example capping circuitry 216, an example report generation circuitry 218.

The example interface 200 of FIG. 2 obtains data from the example storages 120, 122, 124, 126 of FIG. 1 that is used to generate the match panel and determine deduplication audience totals based on the match panel. For example, the interface 200 obtains television impression data from the television data storage 120, television reach data from the television data storage 120, respondent level impressions data from the digital data storage 122, desktop reach data from the digital data storage 122, mobile reach data from the digital data storage 122, panelist information from the panelist storage 126, and DEP account information from the DEP account storage 124. Additionally, the example interface 200 can output a report generated by the report generation circuitry 218. The report may be output to a user (e.g., via a user interface) and/or as a data signal to another processing device.

The example comparator 202 of FIG. 2 can compare panelist information to DEP account information to identify match(es) based on preselected PII combination(s). The PII may include birth year, birth month, first name, last name, zip code, street name, city state, email, phone number, etc. PII combinations may include any combinations of PII information that match. An example of PII combinations is shown below in Table 1. The below table includes PII combinations and corresponding ranks. The rank corresponds to the strength of the match. However, other combinations and/or rank order may be used.

TABLE &num;1

| PII Combinations | Rank Order |
|---|---|
| doby_dobm_ln_fn_email | 1 |
| doby_dobm_ln_fn_phone | 2 |
| doby_dobm_fn_email | 3 |
| doby_dobm_fn_phone | 4 |
| ln_fn_doby_dobm_addr1_ct_st_zip | 5 |
| fn_doby_dobm_addr1_ct_st_zip | 6 |
| ln_fn_doby_dobm_strn_ct_st_zip | 7 |
| ln_doby_dobm_strn_ct_st_zip | 8 |
| doby_ln_fn_email | 9 |
| doby_ln_fn_phone | 10 |
| doby_fn_email | 11 |
| doby_fn_phone | 12 |
| ln_fn_doby_addr1_ct_st_zip | 13 |
| fn_doby_addr1_ct_st_zip | 14 |
| ln_fn_strn_ct_st_zip | 15 |
| ln_fn_doby_dobm_zip | 16 |
| ln_fn_email | 17 |
| ln_fn_phone | 18 |
| fn_email | 19 |
| fn_phone | 20 |
| doby_dobm_ln_email | 21 |
| doby_dobm_ln_phone | 22 |
| doby_dobm_email | 23 |
| doby_dobm_phone | 24 |
| doby_ln_email | 25 |
| doby_ln_phone | 26 |
| ln_fn_addr1_ct_st_zip | 27 |
| ln_doby_dobm_addr1_ct_st_zip | 28 |
| doby_dobm_addr1_ct_st_zip | 29 |
| ln_doby_addr1_ct_st_zip | 30 |
| doby_addr1_ct_st_zip | 31 |
| fn_doby_dobm_strn_ct_st_zip | 32 |
| ln_fi_addr1_ct_st_zip | 33 |
| ln_fi_strn_ct_st_zip | 34 |
| ln_doby_dobm_zip | 35 |
| ln_fn_zip | 36 |
| doby_dobm_strn_ct_st_zip | 37 |
| fn_doby_dobm_zip | 38 |
| ln_phone | 39 |
| ln_email | 40 |

In the above-Table 1, “doby” represents date of birth year, “dobm” represents date of birth month, “ln” represents last name, “fn” represents first name, “strn” represents street name, “ct” represents city, “st” represents state, and “zip” represents zip code. Additionally, the example comparator 202 may compare in-tab percentages to one or more thresholds so that the filter 210 can filter out match panelists that are in-tab by less than the one or more thresholds to ensure that the match panelists provide accurate data. As used herein, in-tab represents when a meter of the panelists properly transmits metering monitoring data to the AME server 118 (e.g., at a predetermined time).

The example ranking circuitry 204 ranks the PII matches of panelists to DEP accounts based on a rank corresponding to the PII combination. For example, using the example of the above-Table 1, the ranking circuitry 204 outputs a ‘1’ rank to a panelist that matches a DEP account based on date of birth year, date of birth month, last name, first name, and email. After panelists and DEP accounts are matched and ranked, there may be multiple panelists that match to a same DEP account and/or multiple DEP accounts matched to the same panelist. Accordingly, the example sorting circuitry 206, grouping circuitry 208, and filter 210 perform a matching protocol to generate a match panel with a 1-to-1 correspondence (e.g., one panelist linked to one DEP account), as further described below.

The example sorting circuitry 206 of FIG. 2 sorts and/or orders the matches by rank (e.g., rank 1 matches first, rank 2 matches second, etc.). After the matches are sorted, the example grouping circuitry 208 generates (a) first groups by grouping the sorted matches by panelist identifier (ID) and (b) second groups by grouping the sorted matches by DEP ID. The example sorting circuitry 206 orders (a) the first groups by rank and (b) the second groups by rank. The example grouping circuitry 208 generates (a) first top rank groups by selecting the top ranked DEP ID for each panelist ID (b) second top rank groups by selecting the top ranked panelist ID for each DEP ID, and (c) combines the first top ranked groups and the second top ranked groups to generate a top ranked group. After the top ranked group is generated, the example filter 210 removes panelist IDs and DEP IDs that appear in the top ranked groups from the ranked and sorted group and the process is repeated until the top ranked group is empty or the ranked and sorted group is empty, thereby resulting in the match panel. Additionally, the example grouping circuitry 208 may combine respondent level advertisement impressions and television impressions to generate respondent-level data for a match panel as part of a process to determine respondent-level data for the match panel.

The example calculation circuitry 212 of FIG. 2 performs calculations to determine observed deduplication data based on respondent-level data of the match panel. Additionally, the example calculation circuitry 212 determines probability distributions corresponding to the observed deduplication across different platform combinations using a Bayesian inference model. The example calculation circuitry 212 may determine the probability distributions of exposure to media across combinations of platforms by determining the distributions in the example order in the below table 2 (although other orders may be used).

TABLE 2
Order of determination of probability distribution

1. Infer p(T), p(D), and p(M) as a function of age and gender.
2. Infer p(T, D) based on p(T) and p(D)
3. Infer p(T, M) based on p(T) and p(M)
4. Infer p(T, M, D) based on all of the probabilities above
5. Infer p(M, D) based on all of the probabilities above
6. Using the probabilities of 1-5, compute the “alone” probabilities
p(T only), p(T and M only), etc.

In the above-Table 2, p(T) is the probability of a media exposure on TV; p(M) is the probability of a media exposure on mobile; p(D) desktop; and p(T, M), p(T, D), p(M, D) are the probabilities of media exposure on a combination of the two respective platforms; and p(T, M, D) is the probability of media exposure on all three. Additionally, the example calculation circuitry 212 determines the probability distributions based on a number of constraints. For example, if p(T)=0.8 and p(D)=0.6, then there cannot be p(T, D)=0.2. In that case, p(T only) would be 0.6, p(D only)=0.4, and p(T & D)=0.2, which is impossible in the real world because the probabilities add up to more than 1. The example calculation circuitry 212 may take into account additional constraints to ensure statistical consistence and a methodologically robust output, as further described below. Using the probabilities and the number of panelists for each age and gender group, the example calculation circuitry 212 can compute probability distributions over how many panelists are expected to have been exposed on the respective platforms and/or combination of platforms. In some examples, the comparator 202 compares these expectations to panel data so that the example calculation circuitry 212 can infer the most likely distributions over the probabilities.

Additionally, the example calculation circuitry 212 can infer probabilities across demographic(s) using a multilevel model with a hierarchical prior. In examples disclosed herein, a prior, such as a hierarchical prior refers to a prior distribution on a prior distribution. For example, the calculation circuitry 212 can infer all of the above probabilities for an arbitrary number of age and gender groups. For example, it may be possible that one age group is less likely to be exposed to an advertisement campaign on mobile devices than another age group (e.g., because the advertisement campaign was aimed primarily at one of the age groups, because one of the age groups is more likely to have a mobile device, etc.). The example calculation circuitry 212 infers each of the probabilities above for each age and gender combination using a multilevel model with a hierarchical prior. As used herein a multilevel model is a statistical model of parameters that vary at more than one level. Multilevel models account for multiple sources of variability. In the disclosed example multilevel model, the probability of exposure depends on some a baseline probability (e.g., a factor dependent on a gender of an individual, an age and gender of the individual, etc.). Accordingly, the example calculation circuitry 212 can account for variability due to demographic and non-demographic factors. Hierarchical priors are a way of sharing information across demographic groups. Without a hierarchical prior, the probabilities of exposure for females 20-24 and males 25-29, for example, would not be related, because those two groups do not overlap in their age or gender. However, a hierarchical prior enables the use of the fact that the two groups are likely to have similar exposure probabilities, when the ages are similar.

Additionally, the example calculation circuitry 212 can determine the percentage of time that match panelists are in-tab. Additionally, the example calculation circuitry 212 can weight match panelist to represent a universe of audience members. Additionally, the example calculation circuitry 212 can perform iterative proportional fitting (IPF) for the probability distributions. IPF allows the observed audience duplication rates to be adjusted according to the information provided by the TV reach and/or DAM reach, resulting in a deduplicated audience total(s) that reflect(s) both observed duplication from the match panel as well as the panel and/or DAM-based reach totals.

The example sampling circuitry 214 of FIG. 2 samples the probability distributions corresponding to the observed deduplication cross platform combinations to generate output probabilities. For example, the sampling circuitry 214 may utilize a Hamiltonian Monte Carlo (HMC) to sample the probability distributions. The HMC generates a combination of the variable (e.g., p(T), p(D), etc.) and uses one combination to generate another. Over time (e.g., multiple iterations), the example sampling circuitry 214 approximate a full set of possible outcomes for the exposure probabilities.

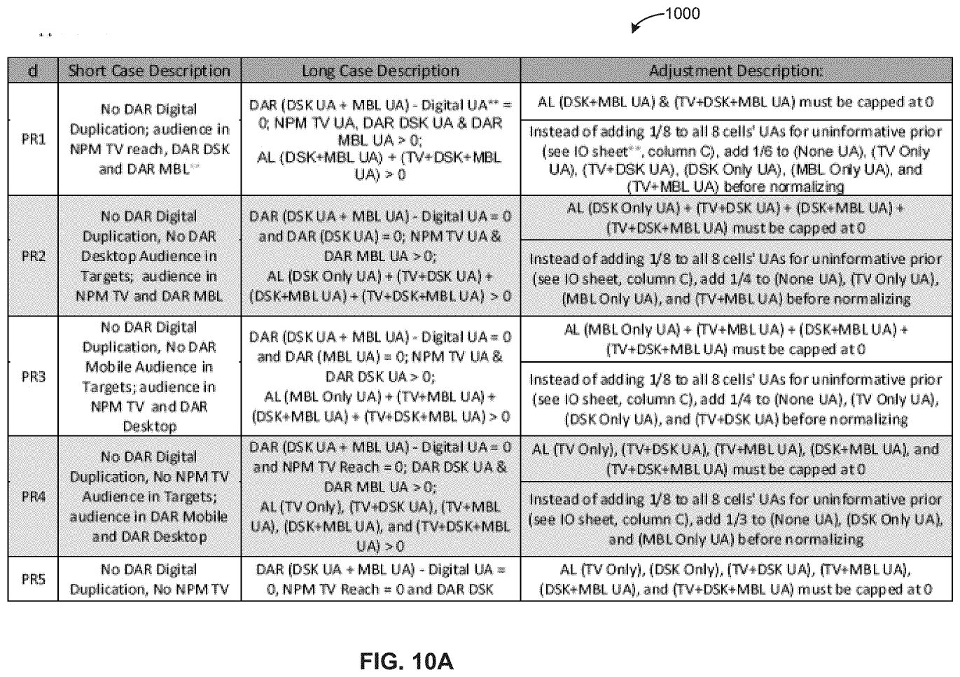

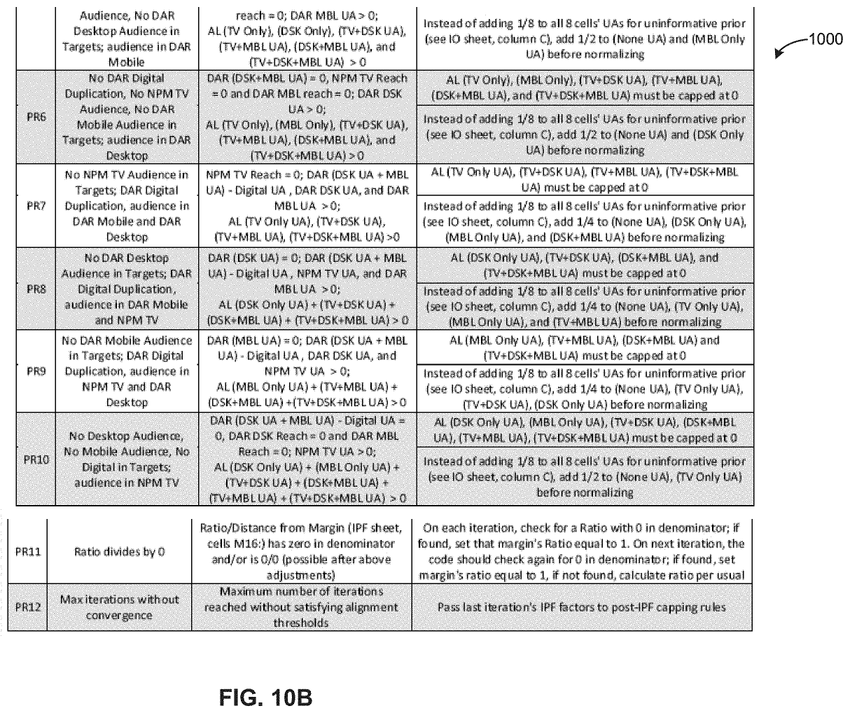

The example capping circuitry 216 of FIG. 2 smooths and/or caps the probabilities output by the sampling circuitry 214 prior and/or post IPF. For example, the capping circuitry 216 may add a predetermined number and/or percentage (e.g., ⅛ the universal estimate) to the probabilities prior to IPF processing to ensure there are no 0's used during the IPF (e.g., to avoid a divide by 0 operation and/or a non-convergence). FIGS. 10A and 10B illustrate other example pre-IPF smoothing and/or capping rules in an example table 1000. Although, other rules may be used. Additionally, the example capping circuitry 216 can perform post-capping rules to adjust the results of the IPF in case the results of the IPF result in one or more results over 100%. An example of post-IPF rules is shown below in Table 3. Although other rules may be applied.

TABLE 3
Post IPF capping Rules

| | Case | Adjustment | | |
|---|---|---|---|---|
| | Description | Description | Technical Description | Timing |
| PF1 | Sum(Post-IPF | Scale None so that | IF SUM(factors) ! = 1: | Post-IPF, pre- |
| | reaches) not equal | sum(Post-IPF reaches) = | None_weights = None_weights + | UA calculation |
| | to 1 | 1, then apply all | (1 − SUM(None_Weights, TV | |
| | | other capping rules to | Only, DSK Only, MBL Only, | |
| | | ensure consistency | TV + DSK, TV + MBL, MBL + | |
| | | | DSK, TV + DSK + MBL)) | |
| PF2 | Post-IPF sum of | Scale post-IPF TV | IF SUM(TV Only, TV + DSK, | Post-IPF, pre- |
| | TV Only, | Only reach so that | TV + MBL, TV + DSK + MBL) ! = | UA calculation |
| | TV + DSK, | sum(TV Only, | NPM TV Reach: TV Only = | |
| | TV + MBL and | TV + DSK, TV + MBL | TV Only + (NPM TV Reach − | |
| | TV + DSK + MBL | and TV + DSK + MBL) = | SUM(TV Only, TV + DSK, | |
| | reach not equal to | NPM TV reach; | TV + MBL, TV + DSK + MBL)) | |
| | NPM TV reach | Adjust None_weights | | |
| | | so SUM(factors) still = 1 | | |
| PF3 | Post-IPF sum of | Scale post-IPF DSK | IF SUM(DSK Only, TV + DSK, | Post-IPF, pre- |
| | DSK Only, | Only reach so that | DSK + MBL, TV + DSK + MBL) ! = | UA calculation |
| | TV + DSK, | sum(DSK Only, | DAR DSK Reach: DSK Only = | |
| | DSK + MBL and | TV + DSK, DSK + MBL | DSK Only + (DAR DSK Reach − | |
| | TV + DSK + MBL | and TV + DSK + MBL) = | SUM(DSK Only, TV + DSK, | |
| | reach not equal to | DAR DSK reach; | DSK + MBL, TV + DSK + MBL)) | |
| | DAR DSK reach | Adjust None_weights | | |
| | | so SUM(factors) still = 1 | | |
| PF4 | Post-IPF sum of | Scale post-IPF MBL | IF SUM(MBL Only, MBL + DSK, | Post-IPF, pre- |
| | MBL Only, | Only reach so that | TV + MBL, TV + DSK + MBL) ! = | UA calculation |
| | MBL + DSK, | sum(MBL Only, | DAR MBL Reach: MBL Only = | |
| | TV + MBL and | MBL + DSK, | MBL Only + (DAR MBL Reach − | |
| | TV + DSK + MBL | TV + MBL and | SUM(MBL Only, MBL + DSK, | |
| | reach not equal to | TV + DSK + MBL) = | TV + MBL, TV + DSK + MBL)) | |
| | DAR MBL reach | DAR MBL reach; | | |
| | | Adjust None_weights | | |
| | | so SUM(factors) still = 1 | | |

The example report generating circuitry 218 of FIG. 2 generates a report including one or more of panel match information, respondent-level data information, observed deduplication information, probability distributions, output probabilities, probabilities across demographic(s), and/or final deduplication information related to reach across the different combinations based on the IPF after capping is performed. The report may be a visual representation of the information (e.g., text, graphs, numbers, etc. to be printed or displayed on a user interface) or a data structure that includes the information (e.g., that can be transmitted to another device).

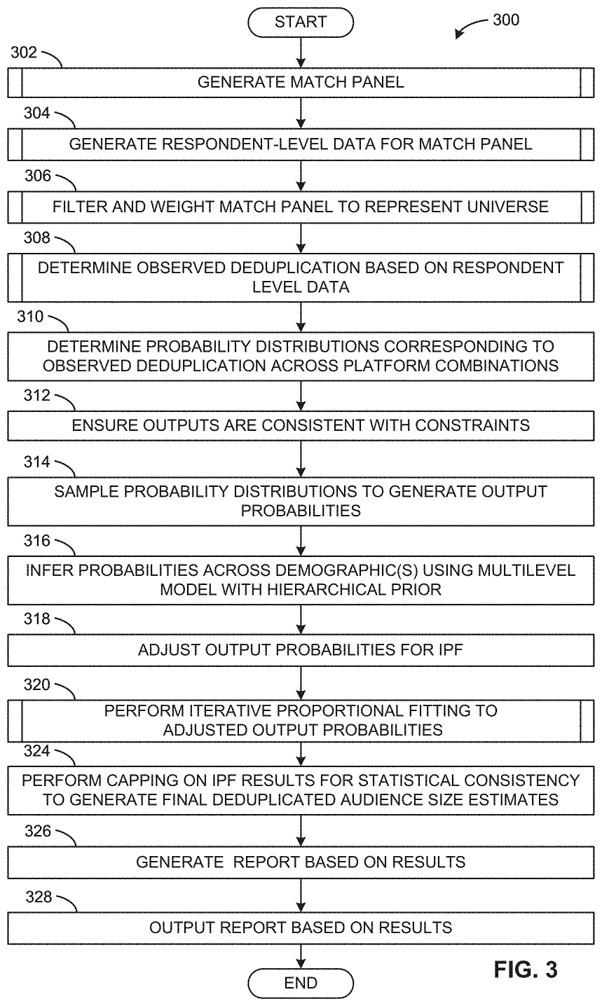

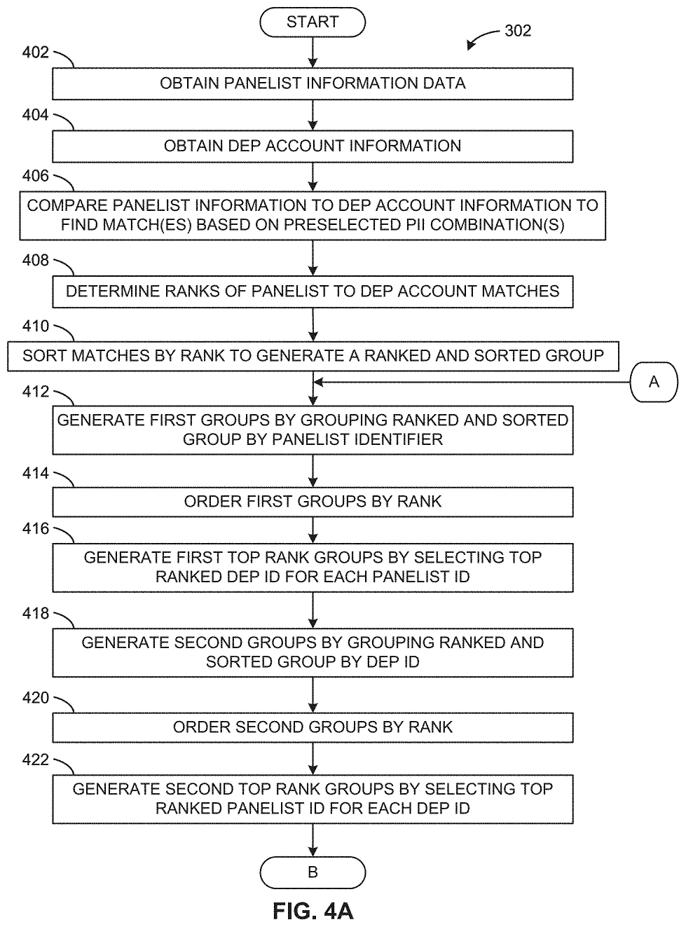

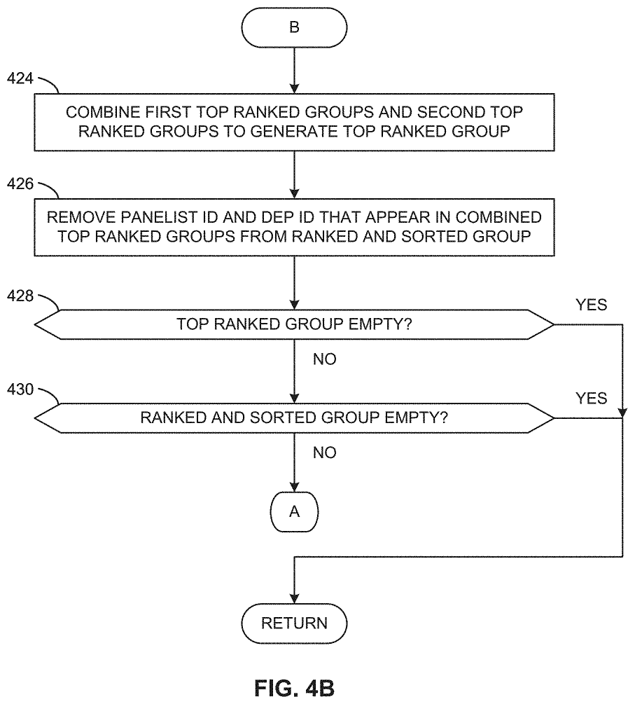

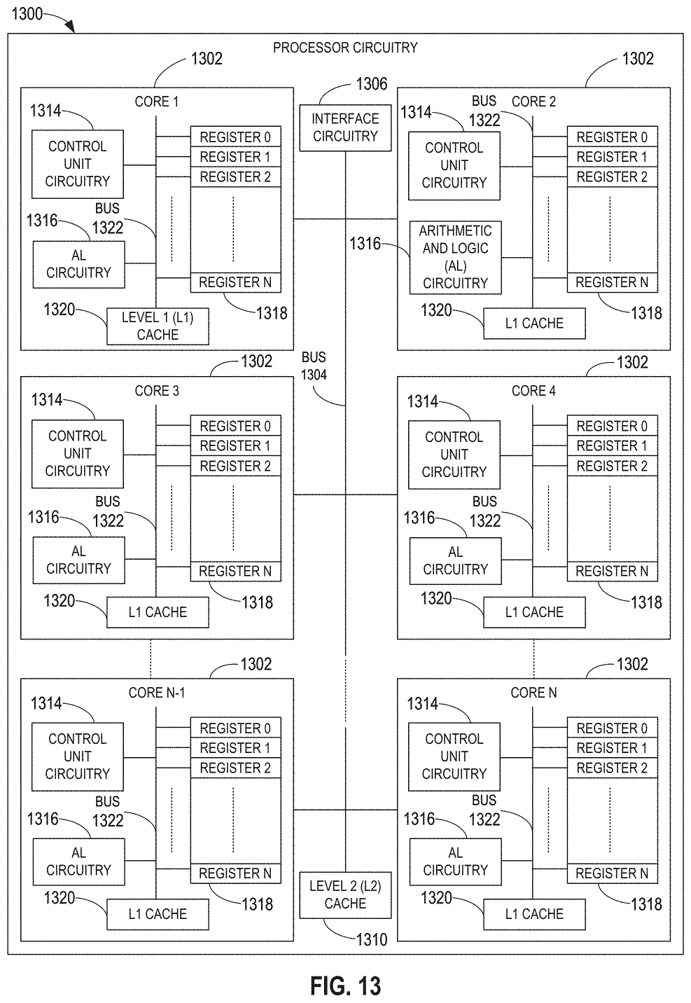

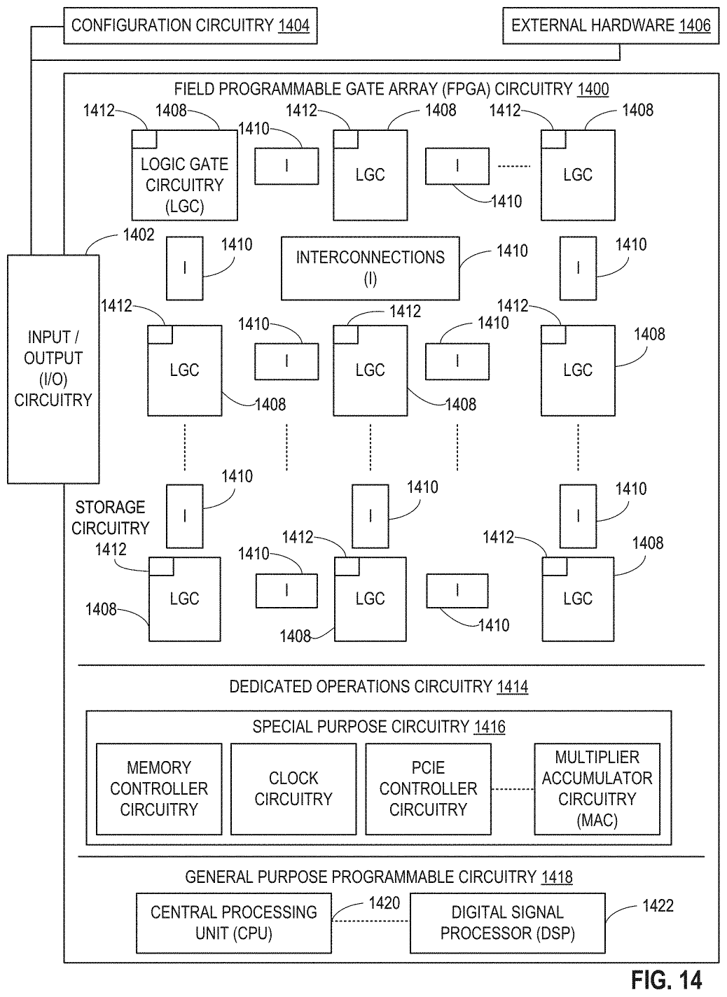

In some examples, the media deduplication circuitry 128 includes means for generating a match panel, means for generating respondent-level data, means for determining a probability distribution, means for performing iterative proportional fitting, means for determining a deduplicated audience, means for sampling a probability distribution, means for capping, smoothing, and/or adjusting output probabilities, means for filtering out panelists, means for weighting panelists, and/or means for outputting a report. For example, the means for generating a match panel may be implemented by at least one of the comparator 202, the ranking circuitry 204, the sorting circuitry 206, the grouping circuitry 208, and/or the filter 210. Example means for determining a probability distribution may be implemented by the calculation circuitry 212. Example means for generating respondent-level data may be implemented by the grouping circuitry 208. Example means for performing iterative proportional fitting may be implemented by the calculation circuitry 212. Example means for determining a deduplicated audience may be implemented by the calculation circuitry 212. Example means for sampling a probability distribution may be implemented by the sampling circuitry 214. Example means for capping, smoothing, and/or adjusting output probabilities may be implemented by the capping circuitry 216. Example means for means for filtering out panelists may be implemented by the filter 210. Example means for weighting panelists may be implemented by the calculation circuitry 212. Example the means for outputting a report may be implemented by the example report generation circuitry 218. In some examples, the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, and/or the example report generation circuitry 218 may be instantiated by processor circuitry such as the example processor circuitry 412 of FIG. 4. For instance, the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, and/or the example report generation circuitry 218 may be instantiated by the example general purpose processor circuitry 1300 of FIG. 13 executing machine executable instructions such as that implemented by at least the blocks of FIGS. 3-8. In some examples, the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, and/or the example report generation circuitry 218 may be instantiated by hardware logic circuitry, which may be implemented by an ASIC or the FPGA circuitry 1400 of FIG. 14 structured to perform operations corresponding to the machine readable instructions. Additionally or alternatively, the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, and/or the example report generation circuitry 218 may be instantiated by any other combination of hardware, software, and/or firmware. For example, the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, and/or the example report generation circuitry 218 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the media deduplication circuitry 128 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, the example report generation circuitry 218, and/or, more generally, the example media deduplication circuitry 128 of FIG. 1, may be implemented by hardware alone or by hardware in combination with software and/or firmware. Thus, for example, any of the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, the example report generation circuitry 218, and/or, more generally, the example media deduplication circuitry 128, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example media deduplication circuitry 128 of FIG. 1 may include one or more elements, processes, and/or devices in addition to, or instead of, those illustrated in FIG. 2, and/or may include more than one of any or all of the illustrated elements, processes and devices.

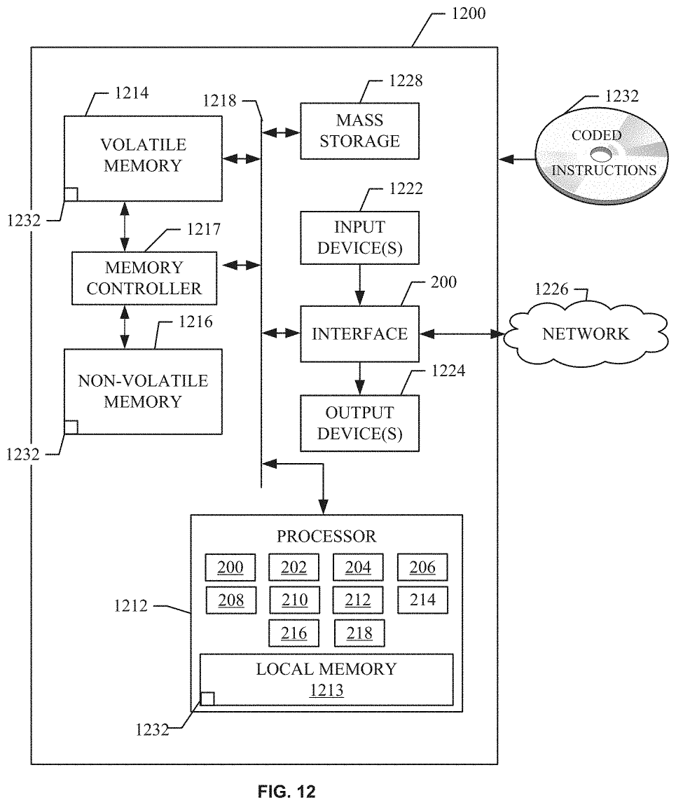

Flowcharts representative of example hardware logic circuitry, machine readable instructions, hardware implemented state machines, and/or any combination thereof for implementing the media deduplication circuitry 128 of FIG. 2 are shown in FIGS. 3-8. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 3-8, many other methods of implementing the example media deduplication circuitry 128 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. [figure nos.] may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to determine deduplicated reach information across different combinations of media delivery platforms (e.g., television, mobile, desktop, etc.) and generate a report of the same. The machine readable instructions and/or the operations 300 of FIG. 3 begin at block 302, at which the example media-deduplication circuitry 128 of FIG. 2 generates a match panel based on panelist information and DEP account information, as further described below in conjunction with FIGS. 4A and 4B.

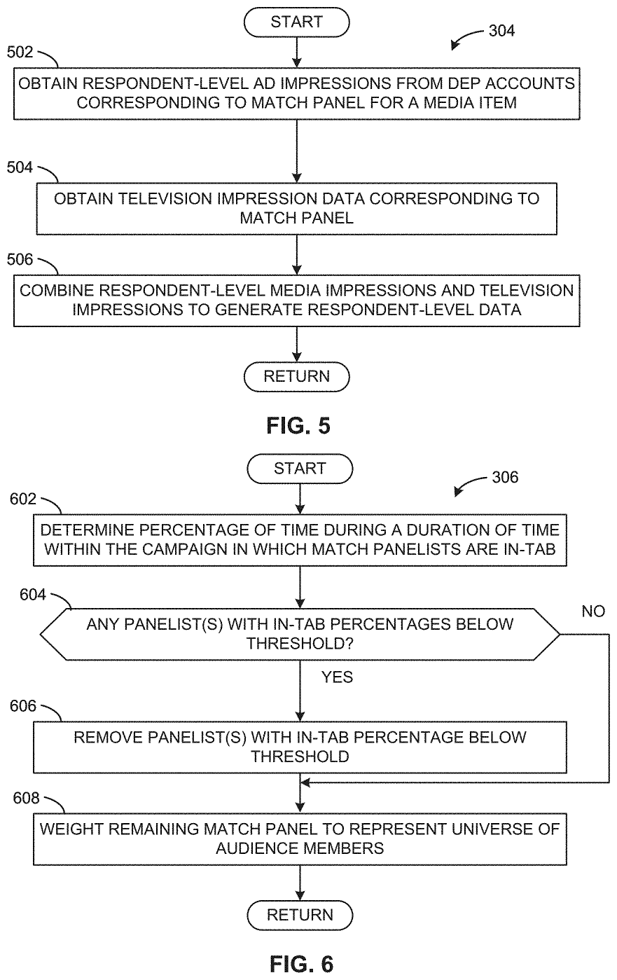

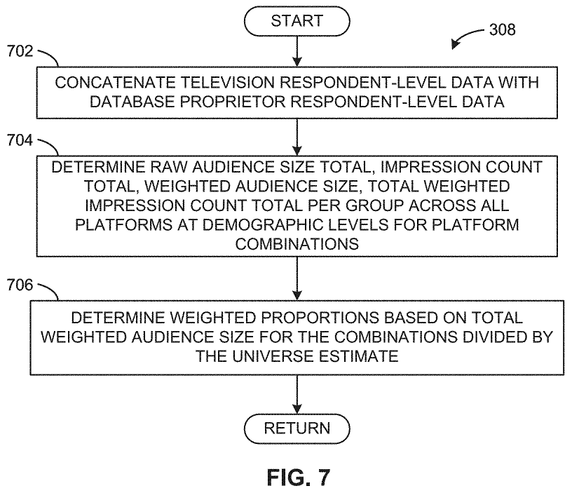

At block 304, the example media-deduplication circuitry 128 (FIG. 2) generates respondent-level data for the match panel corresponding to exposure to media across the different platforms (e.g., television, mobile, desktop, etc.), as further described below in conjunction with FIG. 5. At block 306, the example media-deduplication circuitry 128 filters and weights the match panel to represent the universe, as further described below in conjunction with FIG. 6. At block 308, the example media-deduplication circuitry 128 determines observed deduplication information based on the respondent-level data of the filtered and weighted match panel, as further described below in connection with FIG. 7. The observed deduplication represents the total number of deduplication audience members that were exposed to the different combinations of platforms (e.g., (1) television only, (2) desktop only, (3) mobile only, (4) television and desktop only, (5) desktop and mobile only, (6) television and mobile only, and (7) all of television, desktop, and mobile) based on the weighted and filtered match panel.

At block 310, the example calculation circuitry 212 (FIG. 2) determines the probability distributions corresponding to observed deduplication across platform combinations (e.g., using a Bayesian inference model). For example, as described above in conjunction with FIG. 2, the example calculation circuitry 212 may infer probabilities in a particular order (e.g., corresponding to the above Table 2). At block 312, the example calculation circuitry 212 ensures that the outputs are consistent with various constraints corresponding to real-world constraints. The constraints ensure a statistically consistent and methodologically robust output so that the inferred probabilities can exist in a manner that is valid in the real-world (e.g., a total audience size across multiple platforms is not less than an observed audience of a single platform or does not exceed a sum of the individual audiences observed on the individual platforms). Example constraints are further described below. At block 314, the example sampling circuitry 214 (FIG. 2) samples the probability distribution to generate output probabilities. For example, as further described above in conjunction with FIG. 2, the example sampling circuitry 214 use a HMC technique to sample the results by generating a combination of variables and using the combination to generate another combination of variable over multiple iterations.

At block 316, the example calculation circuitry 212 infers probabilities across demographic(s) using a multilevel model with hierarchical prior. As described above in conjunction with FIG. 2, multilevel models account for multiple sources of variability to account for variability due to demographic and non-demographic factors. At block 318, the example capping circuitry 216 (FIG. 2) adjusts the output probabilities for IPF to align with constraints (e.g., a pre-IPF technique). For example, the capping circuitry 216 may adjust the output probabilities to ensure that none of the numbers correspond to 0 (e.g., to avoid a divide by 0 or a non-convergent result during the IPF) may add a predefined number and/or percentage of audience members to each output probability. Additionally, the example capping circuitry 216 may apply one or more of the capping and/or smoothing rules of the example table 1000 of FIGS. 10A and 10B to ensure that the IPF routine will not result in a divide by zero operation or a non-convergence result. The example table 1000 of FIGS. 10A-10B illustrate example rules. However, a different set of rules may be used.

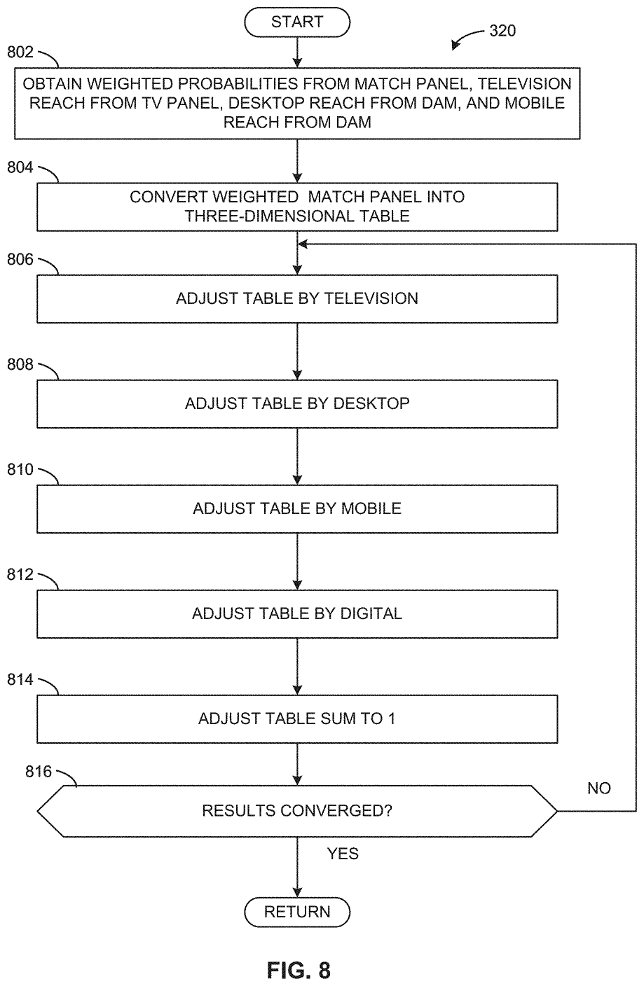

At block 320, the example media deduplication circuitry 128 of FIG. 2 performs IPF to the adjusted the output probabilities, as further described below in conjunction with FIG. 8. As described above, the example media deduplication circuitry 128 performs IPF to allow for observed audience duplication rates to be adjusted according to the information provided by TV and DAR reaches. At block 324, the example capping circuitry 216 performs post-IPF capping on IPF results for statistical consistency. In the example of FIG. 3, the capping can be done to generate final duplicated audience size estimates. For example, the capping circuitry 216 can prevent probabilities from being above 100%. In some examples, the capping circuitry 216 may utilize the capping rules of the above-Table 3. At block 326, the example report generation circuitry 218 (FIG. 2) generates a report based on the results. The report may be a data structure including the results and/or a graphical representation of the results. The report based on the results may include one or more of panel match information, respondent-level data information, observed deduplication information, probability distributions, output probabilities, probabilities across demographic(s), and/or final deduplication information related to reach across the different combinations based on the IPF after capping is performed. At block 328, the example interface 200 outputs the report based on the results. The example interface 200 may output the results to a user interface (e.g., to display the results) and/or to another device (e.g., for further processing and/or to transmit wirelessly to another device). The example instructions of FIG. 3 then end.

FIG. 4 is a flowchart representative of example machine readable instructions and/or example operations 302 that may be executed and/or instantiated by processor circuitry to generate a match panel. The example machine readable instructions and/or the operations 302 of FIG. 4 begin at block 402, at which the example interface 200 (FIG. 2) obtains panelist information data from the panelist storage 126. The panelist information may include details related to the people of the panel (e.g., name, location information, demographic information, etc.).

At block 404, the interface 200 obtains DEP account information from the DEP account storage 124. The DEP account information may include details related to the DEP accounts (e.g., name, location information, demographic information, etc.). At block 406, the example comparator 202 (FIG. 2) compares the panelist information to the DEP account information to find match(es) based on preselected PII combination(s). In some examples, the comparator 202 may use the example PII combinations of the above Table 1. At block 408, the example ranking circuitry 204 (FIG. 2) determines the ranks of the panelist to DEP account matches. For example, the ranking circuitry 204 may determine the ranks based on the example ranks listed in the above Table 1 that correspond to various PII combinations.

At block 410, the example sorting circuitry 206 (FIG. 2) sorts the matches by rank to generate a ranked and sorted group. For example, the sorting circuitry 206 sorts the matches to list the rank 1 matches first, the rank 2 matches second, the rank 3 matches third, etc. At block 412, the example grouping circuitry 208 (FIG. 2) generates first groups by grouping the ranked and sorted group by panelist identifier (e.g., each group including all the ranked and sorted matches corresponding to a single panelist identifier). At block 414, the example sorting circuitry 206 orders the first groups by rank. At block 416, the example grouping circuitry 208 generates first top rank groups by selecting the top ranked DEP identifier for each panelist identifier.

At block 418, the example grouping circuitry 208 generates second groups by grouping the ranked and sorted groups by DEP identifier (e.g., each group including all the ranked and sorted matches corresponding to a single DEP identifier). At block 420, the example sorting circuitry 206 orders the second groups by rank. At block 422, the example grouping circuitry 208 generates second top rank groups by selecting the top ranked panelist ID for each DEP identifier.

At block 424 of FIG. 4B, the example grouping circuitry 208 combines the first top ranked groups and second top ranked groups to generate a top ranked group. At block 426, the example filter 210 (FIG. 2) removes panelist identifiers and DEP identifiers that appear in the combined top ranked groups from the ranked and sorted group. At block 428, the example grouping circuitry 208 determines if the top ranked group is empty (e.g., no longer includes any panelists as entries of the top ranked group). For example, after the first iteration, the top ranked group is not empty, but after additional iterations, the top ranked group generated at block 424 may be empty. If the example grouping circuitry 208 determines that the top ranked group is empty (block 428: YES), then the match panel will correspond to a 1-1 match between a panelist and a DEP account and control will return to block 304 of FIG. 3. If the example grouping circuitry 208 determines that the top ranked group is not empty (block 428: NO), the example grouping circuitry 208 determines if the ranked and sorted group is empty (block 430). If the example grouping circuitry 208 determines that the ranked and sorted group is empty (block 428: YES), then the match panel will correspond to a 1-1 match between a panelist and a DEP account and control will return to block 304 of FIG. 3. If the example grouping circuitry 208 determines that the ranked and sorted group is not empty (block 430: NO), then control returns to block 412 to perform another iteration. The example instructions of FIGS. 4A and 4B end.

FIG. 5 is a flowchart representative of example machine readable instructions and/or example operations 304 that may be executed and/or instantiated by processor circuitry to generate respondent-level data for the match panel. The example machine readable instructions and/or the operations 304 of FIG. 5 begin at block 502, at which the example interface 200 (FIG. 2) obtains respondent level ad impression counts from DEP accounts corresponding to the match panel for a campaign from the digital data storage 122.

At block 504, the example interface 200 obtains television impression data corresponding to the match panel. At block 506, the example grouping circuitry 208 (FIG. 2) combines the respondent level ad impressions for DEP accounts corresponding to the match panel and the television impressions for panelist corresponding to the match panel to generate respondent-level data across platforms (e.g., television, mobile, desktop) for the match panel. After block 506, control returns to block 306 of FIG. 3.

FIG. 6 is a flowchart representative of example machine readable instructions and/or example operations 306 that may be executed and/or instantiated by processor circuitry to filter and weight the panelist in the match panel to represent a universe of audience members. The example machine readable instructions and/or the operations 306 of FIG. 6 begin at block 602, at which the example calculation circuitry 212 (FIG. 2) determines the percentage of time during a duration of time within the campaign in which the match panelists are in-tab. The percentage of time in-tab corresponds to more reliable panelists to better represent a universe. Accordingly, the amount of time that panelist are in-tab may be used to filter out less reliable panelists from the match panel.

At block 604, the example comparator 202 (FIG. 2) compares the determined percentages of time to a threshold to determine if there are panelists within in-tab percentages below a threshold. The threshold may be based on user and/or manufacturer preferences. If the example comparator 202 determines that there are not panelist(s) of the match panel with in-tab percentages below the threshold (block 604: NO), control continues to block 608. If the example comparator 202 determines that there are panelists of the match panel with in-tab percentages below the threshold (block 604: YES), the example filter 210 (FIG. 2) removes the panelist(s) from the match panel for a duration of time (block 606) (e.g., until another duration when the in-tab percentage is re-calculated (e.g., a 2 week of a month campaign)). At block 608, the example calculation circuitry 212 weights the remaining panelists of the match panel to represent the universe of audience members. After block 608, control returns to block 308 of FIG. 3.

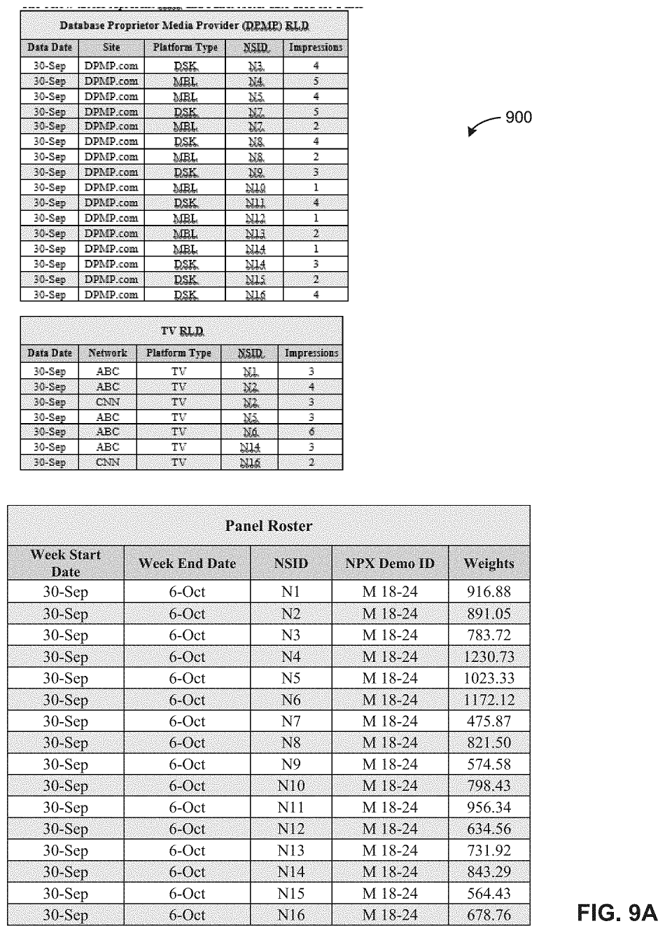

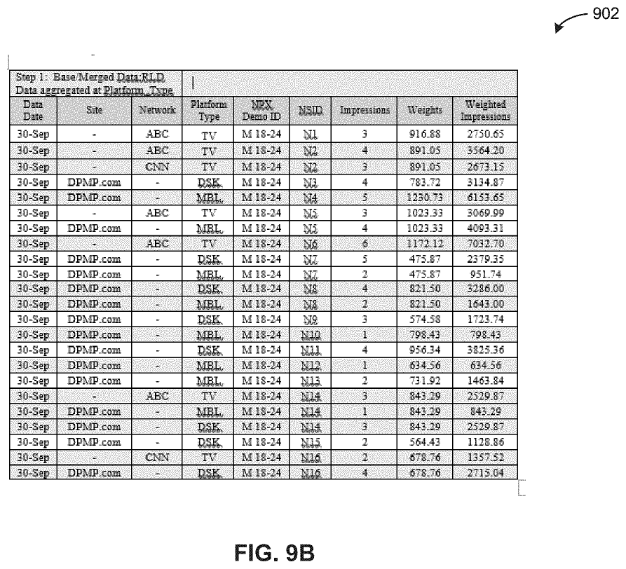

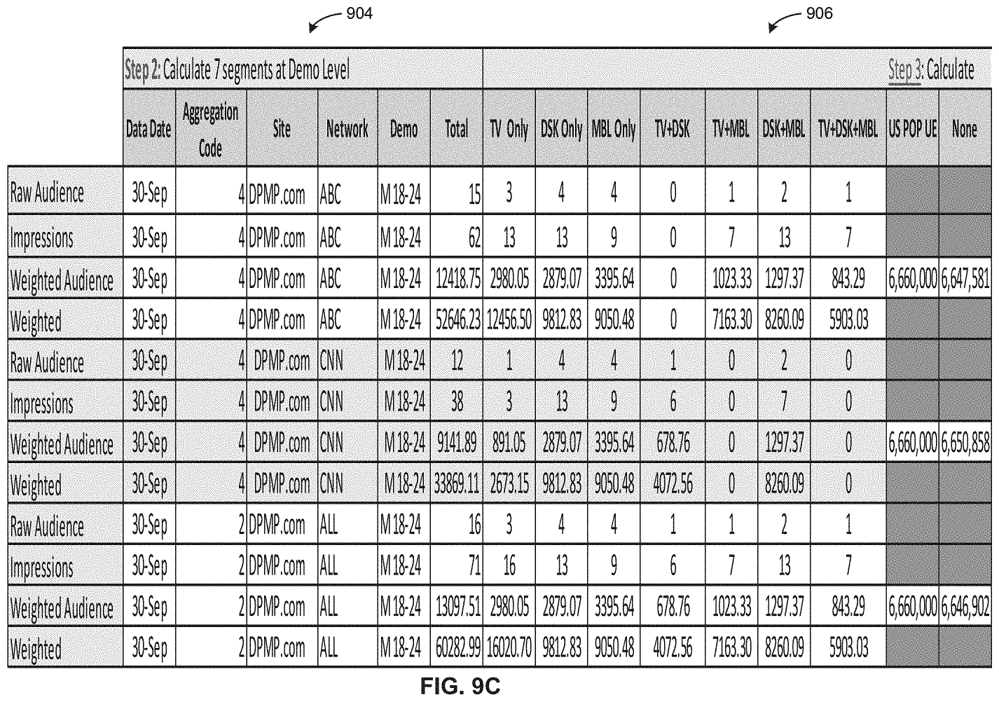

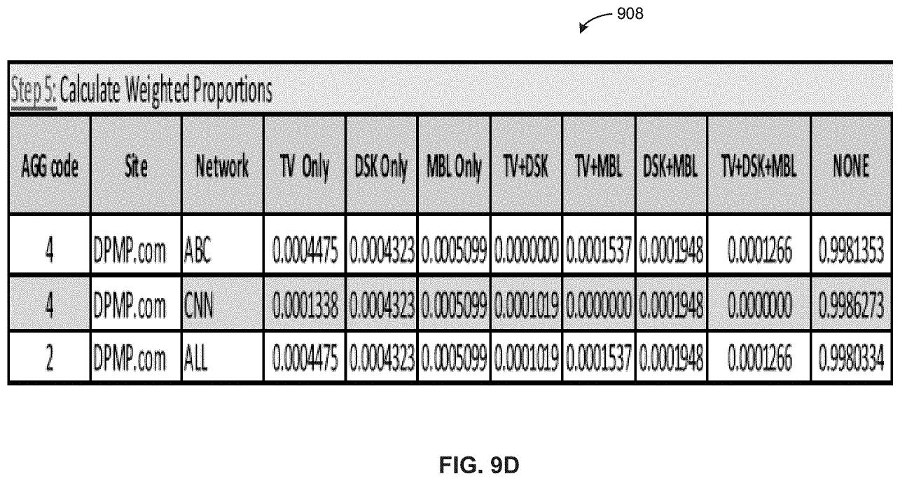

FIG. 7 is a flowchart representative of example machine readable instructions and/or example operations 308 that may be executed and/or instantiated by processor circuitry to determine observed deduplication based on respondent-level data. The example operations 308 of FIG. 7 are described in conjunction with the example data of FIGS. 9A-9D. The data of FIGS. 9A-9D illustrate one example. However, other examples may be used. The example machine readable instructions and/or the operations 308 of FIG. 7 begin at block 702, at which the example calculation circuitry 212 (FIG. 2) concatenates television respondent-level data with database proprietor respondent-level data and joins the merged dataset with the panel roster information. In the example of FIGS. 9A-9D, example tables 900 of FIG. 9A represent an example of respondent-level data (RLD) from the database proprietor, the television panelists, and the matched panel. Accordingly, the example calculation circuitry 212 concatenates the television RLD dataset with the DEP RLD dataset and joins the merged dataset with the panel roster information, as shown in the example table 902 of FIG. 9B.

At block 704, the example calculation circuitry 212 determines the raw audience size total, the impression size total, the weighted audience size, the total weighted impression count total per group across all platforms at demographic levels for platform combinations. For example, the tables 904, 906 of FIG. 9C illustrate an example of the raw audience total, the impression count total, the weighted audience, the total weighted impression count total per group across all platforms at demographic levels for platform combinations that may be calculated by the example calculation circuitry 212 using the information from the example table 902 of FIG. 9B. In some examples, the calculation circuitry 212 applies collapsing to the total weighted audiences using collapsing rules. At block 706, the example calculation circuitry 212 determines the weighted proportions based on the total weighted audience for the combinations divided by the universe estimate. For example, the table 908 of FIG. 9D illustrates an example the weighted proportions that can be calculated by the example calculation circuitry 212 using the information from the example table 904, 906 of FIG. 9C.

FIG. 8 is a flowchart representative of example machine readable instructions and/or example operations 320 that may be executed and/or instantiated by processor circuitry to perform iterative proportional fitting to the adjusted output probabilities. The example machine readable instructions and/or the operations 320 of FIG. 8 begin at block 802, at which the example interface 200 (FIG. 2) obtains the weighted probabilities from the match panel, television reach total(s) from the television panel (e.g., via the television data storage 120), desktop reach total(s) from DAM (e.g., via the digital data storage 122), mobile reach total(s) from DAM (e.g., via the digital data storage 122), and digital reach total(s) from DAM (e.g., via the digital data storage 122).

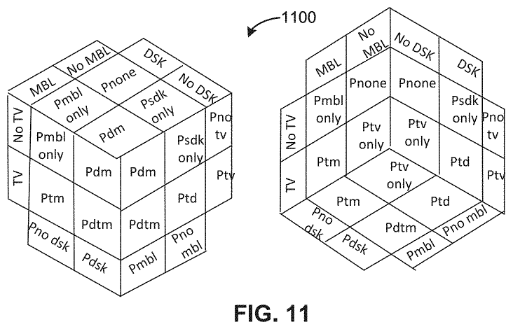

At block 804, the example grouping circuitry 208 (FIG. 2) converts the weighted match panel into a three-dimensional table corresponding to the different combinations of platforms (e.g., television, desktop, mobile). If a different number of platforms are used, the table may include a different number of dimensions. An example graphical representation 1100 of the three-dimensional table is illustrated in FIG. 11. In the example graphical representation 1100, TV corresponds to television, MBL corresponds to mobile, DSK corresponds to desktop, p_{TV} only corresponds to the probability of only television exposure, “p_{DSK} only” corresponds to probability of only desktop exposure, “p_{MBL} only” corresponds to probability of exposure to mobile only, p_{TM} corresponds to probability of exposure to television and mobile only, p_{TD} corresponds to probability of exposure to television and desktop only, p_{DM} corresponds to probability of exposure to desktop and mobile only, p_{TDM} corresponds to probability of exposure to television, mobile, and desktop, and phone corresponds to probability of no platform-based media exposure.

At block 806, the example calculation circuitry 212 (FIG. 2) adjusts the table based on television data. For example, the calculation circuitry 212 may calculate initial adjustment ratios for television (R_{TV}) using the below Equation 1 and may update cells using a new ratio corresponding to the below Equations 2-5.

$$\begin{matrix}{R}_{TV} = \frac{{Reach}_{TV}}{{p}_{TV Only} + {p}_{TM} + {p}_{TD} + {p}_{TDM}} & ( Equation 1 ) \\ {{p}_{TV Only}}^{′} = {p}_{TV Only} {R}_{TV} & ( Equation 2 ) \\ {{p}_{TD}}^{′} = {p}_{TD} {R}_{TV} & ( Equation 3 ) \\ {{p}_{TM}}^{′} = {p}_{TM} {R}_{TV} & ( Equation 4 ) \\ {{p}_{TDM}}^{′} = {p}_{TDM} {R}_{TV} & ( Equation 5 )\end{matrix}$$

At block 808, the example calculation circuitry 212 adjusts the table based on desktop data. For example, the calculation circuitry 212 may calculate initial adjustment ratios for desktop (R_{Desktop}) using the below Equation 6 and may update cells using a new ratio corresponding to the below Equations 7-10.

$$\begin{matrix}{R}_{Desktop} = \frac{{Reach}_{Desktop}}{{p}_{DSK Only} + {p}_{DM} + {p}_{TD} + {p}_{TDM}} & ( Equation 6 ) \\ {{{p}_{DSK Only}}^{′}}^{′} = {p}_{DSK Only} {R}_{Desktop} & ( Equation 7 ) \\ {{{p}_{TD}}^{′}}^{′} = {{p}_{TD}}^{′} {R}_{Desktop} & ( Equation 8 ) \\ {{{p}_{DM}}^{′}}^{′} = {p}_{DM} {R}_{Desktop} & ( Equation 9 ) \\ {{{p}_{TDM}}^{′}}^{′} = {{p}_{TDM}}^{′} {R}_{Desktop} & ( Equation 10 )\end{matrix}$$

At block 810, the example calculation circuitry 212 adjusts the table based on mobile data. For example, the calculation circuitry 212 may calculate initial adjustment ratios for mobile (R_{mobile}) using the below Equation 11 and update cells using a new ratio corresponding to the below Equations 12-15.

$$\begin{matrix}{R}_{mobile} = \frac{{Reach}_{Mobile}}{{p}_{MBL Only} + {p}_{DM} + {p}_{TM} + {p}_{TDM}} & ( Equation 11 ) \\ {{{{p}_{MBL Only}}^{′}}^{′}}^{′} = {p}_{MBL Only} {R}_{Mobile} & ( Equation 12 ) \\ {{{{p}_{TM}}^{′}}^{′}}^{′} = {{p}_{TM}}^{′} {R}_{Mobile} & ( Equation 13 ) \\ {{{{p}_{DM}}^{′}}^{′}}^{′} = {{{p}_{DM}}^{′}}^{′} {R}_{Mobile} & ( Equation 14 ) \\ {{{{p}_{TDM}}^{′}}^{′}}^{′} = {{{p}_{TDM}}^{′}}^{′} {R}_{Mobile} & ( Equation 15 )\end{matrix}$$

At block 812, the example calculation circuitry 212 adjusts the table based on digital data (e.g., mobile and desktop). For example, the calculation circuitry 212 may calculate initial adjustment ratios for digital (R_{Digital}) using the below Equation 16 and may update cells using a new ratio corresponding to the below Equations 17-23.

$$\begin{matrix}{R}_{Digital} = \frac{( {Reach}_{Digital} )}{\begin{matrix}{p}_{DSK Only} + {p}_{MBL Only} + \\ {p}_{TD} + {p}_{DM} + {p}_{TM} + {p}_{TDM}\end{matrix}} & ( Equation 17 ) \\ {{{{{p}_{DSK Only}}^{′}}^{′}}^{′}}^{′} = {{{p}_{DSK Only}}^{′}}^{′} {R}_{Digital} & ( Equation 18 ) \\ {{{{{p}_{MBL Only}}^{′}}^{′}}^{′}}^{′} = {{{{p}_{MBL Only}}^{′}}^{′}}^{′} {R}_{Digital} & ( Equation 19 ) \\ {{{{{p}_{TM}}^{′}}^{′}}^{′}}^{′} = {{{{p}_{TM}}^{′}}^{′}}^{′} {R}_{Digital} & ( Equation 20 ) \\ {{{{{p}_{TD}}^{′}}^{′}}^{′}}^{′} = {{{p}_{TD}}^{′}}^{′} {R}_{Digital} & ( Equation 21 ) \\ {{{{{p}_{DM}}^{′}}^{′}}^{′}}^{′} = {{{{p}_{DM}}^{′}}^{′}}^{′} {R}_{Digital} & ( Equation 22 ) \\ {{{{{p}_{TDM}}^{′}}^{′}}^{′}}^{′} = {{{{p}_{TDM}}^{′}}^{′}}^{′} {R}_{Digital} & ( Equation 23 )\end{matrix}$$

At block 814, the example calculation circuitry 212 adjusts the table to sum to 1. For example, the calculation circuitry 212 may calculate initial adjustment ratios (Rₒₙₑ) using the below Equation 24 and may update cells using new ratios corresponding to the below Equations 25-32.

$$\begin{matrix}{R}_{One} = \frac{1}{\begin{matrix}{p}_{None} + {{p}_{TV Only}}^{′} + {{{{{p}_{DSK Only}}^{′}}^{′}}^{′}}^{′} + \\ {p}_{MBL {{{{Only}^{′}}^{′}}^{′}}^{′} + {{{{{p}_{TD}}^{′}}^{′}}^{′}}^{′} + {{{{{p}_{DM}}^{′}}^{′}}^{′}}^{′} +} \\ {{{{{p}_{TM}}^{′}}^{′}}^{′}}^{′} + {{{{{p}_{TDM}}^{′}}^{′}}^{′}}^{′}\end{matrix}} & ( Equation 24 ) \\ {{{{{{p}_{None}}^{′}}^{′}}^{′}}^{′}}^{′} = {p}_{None} {R}_{One} & ( Equation 25 ) \\ {{{{{{p}_{TV Only}}^{′}}^{′}}^{′}}^{′}}^{′} = {{p}_{TV Only}}^{′} {R}_{One} & ( Equation 26 ) \\ {{{{{{p}_{DSK Only}}^{′}}^{′}}^{′}}^{′}}^{′} = {{{{{p}_{DSK Only}}^{′}}^{′}}^{′}}^{′} {R}_{One} & ( Equation 27 ) \\ {{{{{{p}_{MBL Only}}^{′}}^{′}}^{′}}^{′}}^{′} = {{{{{p}_{MBL Only}}^{′}}^{′}}^{′}}^{′} {R}_{One} & ( Equation 28 ) \\ {{{{{{p}_{TM}}^{′}}^{′}}^{′}}^{′}}^{′} = {{{{{p}_{TM}}^{′}}^{′}}^{′}}^{′} {R}_{One} & ( Equation 29 ) \\ {{{{{{p}_{TD}}^{′}}^{′}}^{′}}^{′}}^{′} = {{{{{p}_{TD}}^{′}}^{′}}^{′}}^{′} {R}_{One} & ( Equation 30 ) \\ {{{{{{p}_{DM}}^{′}}^{′}}^{′}}^{′}}^{′} = {{{{{p}_{DM}}^{′}}^{′}}^{′}}^{′} {R}_{One} & ( Equation 31 ) \\ {{{{{{p}_{TDM}}^{′}}^{′}}^{′}}^{′}}^{′} = {{{{{p}_{TDM}}^{′}}^{′}}^{′}}^{′} {R}_{One} & ( Equation 32 )\end{matrix}$$

At block 816, the example calculation circuitry 212 determines if the results have converged on one or more solutions. If the results have not converged one or more solutions (block 816: NO), control returns to block 806 and an additional iteration is performed with the adjusted values until the results converge. If the results have converged on one or more solutions (block 816: YES), control returns to block 322 of FIG. 3.

As described above, the example calculation circuitry 212 ensures that the outputs are consistent with various constraints corresponding to real-world constraints. The constraints ensure a statistically consistent and methodologically robust output so that the inferred probabilities can exist in a manner that is valid in the real world. Example calculations to satisfy various constraints are described below.

For two variable constrains, if X and Y (e.g., X can correspond to television and Y can correspond to desktop) are generic Bernoulli random variables with probabilities px and py, the joint probability of them both occurring is p(x, y). The correlation between X and Y is shown below in Equation 33.

$${ρ}_{XY} = \frac{p ( x , y ) - {p}_{x} {p}_{y}}{\sqrt{{p}_{x} ( 1 - {p}_{x} ) {p}_{y} ( 1 - {p}_{y} )}} \qquad ( Equation 33 )$$

Equivalently, the example calculation circuitry 212 can express the joint probability in terms of correlation using the below Equation 34.

p(x,y)=pₓp_{y}+ρ_{XY}\sqrt{pₓ(1−pₓ)p_{y}(1−p_{y})} (Equation 34)

Because X and Y are independent (e.g., X can be television and Y can be desktop), the correlation between X and Y is zero. Thus, the joint probability p(x,y)=pxpy. When X and Y are positively correlated, Equation 34 illustrates that the joint probability p(x,y) is larger than the product pxpy, which matches the definition of positive correlation. If the correlation is negative, the joint probability is smaller than pxpy. These correlations constrain the joint probability. For example, the smallest correlation (ρ) can be ρ=−1 and the largest correlation can be p=+1, thereby resulting in the below Equations 35 and 36.

p(x,y)≥pₓp_{y}−\sqrt{pₓ(1−pₓ)p_{y}(1−p_{y})} (Equation 35)

p(x,y)≤pₓp_{y}+\sqrt{pₓ(1−pₓ)p_{y}(1−p_{y})} (Equation 36)

Additionally, if px and py are known, then p(x alone)−px+py−p(x,y) and because p(x alone)≤1, we get px+py=p(x,y)≤1 or p(x,y)≥px+py-1. Additionally, p(x,y)≥0 and p(x,y)≤px, py (e.g., the probability of viewing on both x and y must be less than the probability of viewing on x regardless of y). Combining the above information, the example calculation circuitry 212 can constrain the probability of television and desktop (e.g., p(T, D)) when the probability of television (e.g., pT) and the probability of desktop (e.g., pD) are known using the below Equations 37 and 38.

$$\begin{matrix}p ( T , D ) \geq max \{ \begin{matrix}0 \\ {p}_{x} {p}_{y} - \sqrt{{p}_{x} ( 1 - {p}_{x} ) {p}_{y} ( 1 - {p}_{y} )} \\ {p}_{T} + {p}_{D} - 1\end{matrix} & ( Equation 37 ) \\ p ( T , D ) \leq min \{ \begin{matrix}{p}_{T} \\ {p}_{D} \\ {p}_{x} {p}_{y} - \sqrt{{p}_{x} ( 1 - {p}_{x} ) {p}_{y} ( 1 - {p}_{y} )}\end{matrix} & ( Equation 38 )\end{matrix}$$

Accordingly, the example calculation circuitry 212 can determine p(T), p(D) and the probability of mobile (e.g., p(M)), and use Equations 37 and 38 to determine p(T, D) and the probability of television and mobile (e.g., p(T, M)) while satisfying the constraints.

After the example calculation circuitry 212 determines p(T, D) and p(T, M), the example calculation circuitry 212 can determine the probability of television, desktop, and mobile (e.g., p(T, D, M)). To satisfy real-world constraints 0≤p(T, D, M)≤1. Additionally, the probability of viewing on all three platforms cannot exceed the probability of viewing on two platforms when the third platform is ignored. Mathematically, p(T, D, M)≤p(T, D) and p(T, D, M)≤p(T, M). Another constraint may come from the fact that p (T only)=p(T)−p(T, M)−p(T,D)+p(T,M,D). Because p(T only) is still a probability, p(T) is between 0 and 1, thereby resulting in the below Equations 39-41.

0≤p(T only)≤1 (Equation 39)

0≤p(T)−p(T,M)−p(T,D)+p(T,M,D)≤1 (Equation 40)

p(T,M)+p(T,D)−p(T)≤p(T,M,D)≤1−p(T)+p(T,M)+p(T,D) (Equation 41)

Adjusting Equations 39-41 results in the below Equations 42 and 43 (e.g., constraints that the example calculation circuitry 212 utilizes).

$$\begin{matrix}p ( T , D , M ) \geq max \{ \begin{matrix}0 \\ p ( T , M ) + p ( T , D ) - p ( T )\end{matrix} & ( Equation 42 ) \\ p ( T , D , M ) \leq min \{ \begin{matrix}1 \\ p ( T , D ) \\ p ( T , M ) \\ 1 + p ( T , M ) + p ( T , D ) - p ( T )\end{matrix} & ( Equation 43 )\end{matrix}$$

Instead of determining the p(M, D) constraint directly, the example calculation circuitry 212 may determine the correlation ρMD first based on the below Equations 44 and 45.

$$\begin{matrix}{ρ}_{MD} = \frac{p ( M , D ) - {p}_{M} {p}_{D}}{\sqrt{{p}_{M} ( 1 - {p}_{M} ) {p}_{D} ( 1 - {p}_{D} )}} & ( Equation 44 ) \\ p ( M , D ) = {p}_{M} {p}_{D} + {ρ}_{MD} \sqrt{{p}_{M} ( 1 - {p}_{M} ) {p}_{D} ( 1 - {p}_{D} )} & ( Equation 45 )\end{matrix}$$

For brevity, * is used to represent \sqrt{p_{M}(1−p_{M})p_{D}(1−p_{D})}. Because pMD is a correlation −1≤ρMD≤+1. Knowing the correlations ρTD and ρTD constrains the possible values of the correlation ρMD, thereby resulting in the below Equations 46 and 47.

ρ_{MD}≥ρ_{TD}ρ_{TM}−\sqrt{(1−ρ_{TD}²)(1−ρ_{TM}²)} (Equation 46)

ρ_{MD}≤ρ_{TD}ρ_{TM}+\sqrt{(1−ρ_{TD}²)(1−ρ_{TM}²)} (Equation 47)

The Below Equations 48-50 result from the fact that the probability of p (M, D) is between 0 and 1.

$$\begin{matrix}0 \leq {p}_{M} {p}_{D} + {ρ}_{MD} (* ) \leq 1 & ( Equation 48 ) \\ - {p}_{M} {p}_{D} \leq {ρ}_{MD} (* ) \leq 1 {p}_{M} {p}_{D} & ( Equation 49 ) \\ \frac{- {p}_{M} {p}_{D}}{(* )} \leq {ρ}_{MD} \leq \frac{1 - {p}_{M} {p}_{D}}{(* )} & ( Equation 50 )\end{matrix}$$

The total probability pD+pM−p(M, D) is also between 0 and 1, which further constrains ρMD, resulting in Equations 52-55 which leads to Equation 56.

$$\begin{matrix} 0 \leq {p}_{D} + {p}_{M} - p ( M , D ) \leq 1 & ( Equation 52 ) \\ 0 \leq {p}_{D} + {p}_{M} - ( {p}_{M} {p}_{D} + {ρ}_{MD} (* ) ) \leq 1 & ( Equation 53 ) \\ {p}_{M} {p}_{D} - {p}_{D} - {p}_{M} \leq ( - {ρ}_{MD} (* ) ) \leq 1 + {p}_{M} {p}_{D} - {p}_{D} - {p}_{M} & ( Equation 54 ) \\ \frac{{p}_{M} {p}_{D} - {p}_{D} - {p}_{M}}{(* )} \leq - {ρ}_{MD} \leq \frac{1 + {p}_{M} {p}_{D} - {p}_{D} - {p}_{M}}{(* )} & ( Equation 55 ) \\ {ρ}_{MD} \leq \frac{- {p}_{M} {p}_{D} + {p}_{D} + {p}_{M}}{(* )} and {ρ}_{MD} \geq \frac{- 1 - {p}_{M} {p}_{D} + {p}_{D} + {p}_{M}}{(* )} & ( Equation 56 )\end{matrix}$$

As described above, the constraint 0≤p(T only)≤1 constrains the allowed values of p(T, M, D). Likewise, the below Equation 57 is known, which needs to be between 0 and 1 resulting in the Equations 58, 59, 60.

p(M only)=p(M)−p(T,M)−p(M,D)+p(T,M,D) (Equation 57)

0≤p(M)−p(T,M)−p(M,D)+p(T,M,D)≤1 (Equation 58)

p(M,D)≤p(M)−p(T,M)+p(T,M,D) (Equation 59)

p(M,D)≥p(M)−p(T,M)+p(T,M,D)−1 (Equation 60)

Turning this bound on the correlation using the above Equation 45, resulting in the below Equations 61-66, which the example calculation circuitry 212 can use as constraints.

$$\begin{matrix}{p}_{M} {p}_{D} + {ρ}_{MD} (* ) \leq {p}_{M} - p ( T , M ) + p ( T , M , D ) & ( Equation 61 ) \\ {ρ}_{MD} (* ) \leq {p}_{M} - p ( T , M ) + p ( T , M , D ) - {p}_{M} {p}_{D} & ( Equation 62 ) \\ {ρ}_{MD} \leq \frac{{p}_{M} - p ( T , M ) + p ( T , M , D ) - {p}_{M} {p}_{D}}{(* )} & ( Equation 63 ) \\ {p}_{M} {p}_{D} + {ρ}_{MD} (* ) \geq {p}_{M} - p ( T , M ) + p ( T , M , D ) - 1 & ( Equation 64 ) \\ {ρ}_{MD} (* ) \geq {p}_{M} - p ( T , M ) + p ( T , M , D ) - 1 - {p}_{M} {p}_{D} & ( Equation 65 ) \\ {ρ}_{MD} \geq \frac{{p}_{M} - p ( T , M ) + p ( T , M , D ) - 1 - {p}_{M} {p}_{D}}{(* )} & ( Equation 66 )\end{matrix}$$

The derivation of desktop platform alone is identical to mobile platform alone. Using the above constraint information results in the below Equation 67-69. The example calculation circuitry 212 can determine ρMD based on the bounds/constraints of Equations 68 and 69 and then compute p(M, D) as a function of the bounds/constraints.

$$\begin{matrix}\frac{\begin{matrix}{p}_{M} - p ( T , M ) + \\ p ( T , M , D ) - 1 - {p}_{M} {p}_{D}\end{matrix}}{(* )} \leq {ρ}_{MD} \leq \frac{\begin{matrix}{p}_{M} - p ( T , M ) + \\ p ( T , M , D ) - {p}_{M} {p}_{D}\end{matrix}}{(* )} & ( Equation 67 ) \\ {ρ}_{MD} \geq max \{ \begin{matrix}- 1 \\ {ρ}_{TD} {ρ}_{TM} - \sqrt{( 1 - {{ρ}_{TD}}^{2} ) ( 1 - {{ρ}_{TM}}^{2} )} \\ \frac{- {p}_{M} {p}_{D}}{(* )} \\ \frac{{p}_{D} + {p}_{M} - {p}_{M} {p}_{D} - 1}{(* )} \\ \frac{{p}_{M} - p ( T , M ) + p ( T , M , D ) - 1 - {p}_{M} {p}_{D}}{(* )} \\ \frac{{p}_{D} - p ( T , D ) + p ( T , M , D ) - 1 - {p}_{M} {p}_{D}}{(* )}\end{matrix} & ( Equation 68 ) \\ {ρ}_{MD} \leq min \{ \begin{matrix}+ 1 \\ {ρ}_{TD} {ρ}_{TM} + \sqrt{( 1 - {{ρ}_{TD}}^{2} ) ( 1 - {{ρ}_{TM}}^{2} )} \\ \frac{1 - {p}_{M} {p}_{D}}{(* )} \\ \frac{{p}_{D} + {p}_{M} - {p}_{M} {p}_{D}}{(* )} \\ \frac{{p}_{M} - p ( T , M ) + p ( T , M , D ) - {p}_{M} {p}_{D}}{(* )} \\ \frac{{p}_{D} - p ( T , D ) + p ( T , M , D ) - {p}_{M} {p}_{D}}{(* )}\end{matrix} & ( Equation 69 )\end{matrix}$$

FIG. 12 is a block diagram of an example processor platform 1200 structured to execute and/or instantiate the machine readable instructions and/or the operations of FIGS. 3-8 to implement the media deduplication circuitry 128 of FIG. 2. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the example interface 200, the example comparator 202, the example ranking circuitry 204, the example sorting circuitry 206, the example grouping circuitry 208, the example filter 210, the example calculation circuitry 212, the example sampling circuitry 214, the example capping circuitry 216, and the example report generation circuitry 218

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAIVIBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1232, which may be implemented by the machine readable instructions of FIGS. 3-8, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a general purpose microprocessor 1300. The general purpose microprocessor circuitry 1300 executes some or all of the machine readable instructions of the flowcharts of FIGS. 3-8 to effectively instantiate the media deduplication circuitry 128 of FIG. 2 as logic circuits to perform the operations corresponding to those machine readable instructions. In some such examples, the circuitry of FIG. 2 the media deduplication circuitry 128 is instantiated by the hardware circuits of the microprocessor 1300 in combination with the instructions. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 3-8.

The cores 1302 may communicate by a first example bus 1304. In some examples, the first bus 1304 may implement a communication bus to effectuate communication associated with one(s) of the cores 1302. For example, the first bus 1304 may implement at least one of an Inter-Integrated Circuit (I2C) bus, a Serial Peripheral Interface (SPI) bus, a PCI bus, or a PCIe bus. Additionally or alternatively, the first bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may implement at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 3-8 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIG. 3-8. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIG. 3-8. As such, the FPGA circuitry 1400 may be structured to effectively instantiate some or all of the machine readable instructions of the flowcharts of FIG. 3-8 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 3-8 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware (e.g., external hardware circuitry) 1406. For example, the configuration circuitry 1404 may implement interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may implement the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and interconnections 1410 are configurable to instantiate one or more operations that may correspond to at least some of the machine readable instructions of FIGS. 3-8 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIG. 3-8 may be executed by one or more of the cores 1302 of FIG. 13, a second portion of the machine readable instructions represented by the flowcharts of FIG. 3-8 may be executed by the FPGA circuitry 1400 of FIG. 14, and/or a third portion of the machine readable instructions represented by the flowcharts of FIG. 3-8 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1212 of FIG. 12 may be in one or more packages. For example, the processor circuitry 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

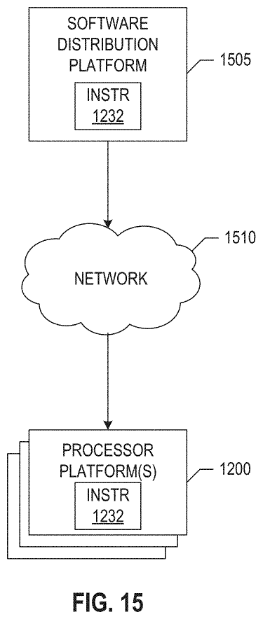

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions of FIGS. 3-8, as described above. The one or more servers of the example software distribution platform 1505 are in communication with a network 1510, which may correspond to any one or more of the Internet and/or any of type of network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIG. 3-8, may be downloaded to the example processor platform 1200, which is to execute the machine readable instructions 1532 to implement the media deduplication circuitry 128. In some example, one or more servers of the software distribution platform 1505 periodically offer, transmit, and/or force updates to the software (e.g., the example machine readable instructions 1232 of FIG. 12 to ensure improvements, patches, updates, etc., are distributed and applied to the software at the end user devices.

Example methods, apparatus, systems, and articles of manufacture to deduplicate audiences across media platforms are disclosed herein. Further examples and combinations thereof include the following: Example 1 includes an apparatus comprising memory, instructions in the apparatus, and processor circuitry to execute the instructions to generate a match panel by matching panelists with database proprietor accounts based on matching information, generate respondent-level data from the match panel by combining first media exposure data corresponding to panelists associated with the match panel and second media exposure data corresponding to the database proprietor accounts associated with the match panel, the first and second media exposure data corresponding to a media item, determine a probability distribution corresponding to observed deduplicated audience size data, the observed deduplicated audience size data based on the respondent-level data of the match panel, perform iterative proportional fitting on an output probability corresponding to the probability distribution, and determine a deduplicated total audience size for the media item based on a result of the iterative proportional fitting.

Example 2 includes the apparatus of example 1, wherein the processor circuitry is to sample the probability distribution to generate the output probability.

Example 3 includes the apparatus of example 2, wherein the processor circuitry is to sample the probability distribution using a Hamilton Monte Carlo technique.

Example 4 includes the apparatus of example 1, wherein the processor circuitry is to perform the iterative proportional fitting to adjust the output probability according to information related at least one of a first reach corresponding to the panelists or a second reach corresponding to database proprietor impressions.

Example 5 includes the apparatus of example 1, wherein the deduplicated audience total corresponds to a reach across platforms, the platforms corresponding to at least one of television, desktop, or mobile.

Example 6 includes the apparatus of example 1, wherein the first media exposure data corresponds to television media and the second media exposure data corresponds to at least one of desktop media or mobile media.

Example 7 includes the apparatus of example 1, wherein the processor circuitry is to add a value to the output probability before performing the iterative proportional fitting to prevent an error during the iterative proportional fitting.

Example 8 includes the apparatus of example 1, wherein the processor circuitry is to cap the result of the iterative proportional fitting for statistical consistency.

Example 9 includes the apparatus of example 1, wherein the processor circuitry is to output a report based on the deduplicated total audience size.

Example 10 includes the apparatus of example 1, wherein the processor circuitry is to filter out a panelist from the match panel based on an in-tab percentage of the panelist.

Example 11 includes the apparatus of example 1, wherein the processor circuitry is to weight panelists of the match panel to represent a universe estimate.

Example 12 includes the apparatus of example 1, wherein the processor circuitry is to the match panel by matching the panelists to the database proprietor accounts based on combinations of matching information, determining ranks of the matches based on corresponding ones of the combinations of matching information, and generating the match panel based on the ranks.

Example 13 includes a non-transitory computer readable medium comprising instructions which, when executed, cause one or more processors to at least generate a match panel by matching panelists with database proprietor accounts based on matching information, generate respondent-level data from the match panel by combining first media exposure data corresponding to panelists associated with the match panel and second media exposure data corresponding to the database proprietor accounts associated with the match panel, the first and second media exposure data corresponding to a media item, determine a probability distribution corresponding to observed deduplicated audience size data, the observed deduplicated audience size data based on the respondent-level data of the match panel, perform iterative proportional fitting on an output probability corresponding to the probability distribution, and determine a deduplicated total audience size for the media item based on a result of the iterative proportional fitting.

Example 14 includes the computer readable storage medium of example 13, wherein the instructions cause the one or more processors to sample the probability distribution to generate the output probability.

Example 15 includes the computer readable storage medium of example 14, wherein the instructions cause the one or more processors to sample the probability distribution using a Hamilton Monte Carlo technique.

Example 16 includes the computer readable storage medium of example 13, wherein the instructions cause the one or more processors to perform the iterative proportional fitting to adjust the output probability according to information related at least one of a first reach corresponding to the panelists or a second reach corresponding to database proprietor impressions.

Example 17 includes the computer readable storage medium of example 13, wherein the deduplicated audience total corresponds to a reach across platforms, the platforms corresponding to at least one of television, desktop, or mobile.

Example 18 includes the computer readable storage medium of example 13, wherein the first media exposure data corresponds to television media and the second media exposure data corresponds to at least one of desktop media or mobile media.

Example 19 includes the computer readable storage medium of example 13, wherein the instructions cause the one or more processors to add a value to the output probability before performing the iterative proportional fitting to prevent an error during the iterative proportional fitting.

Example 20 includes an apparatus comprising processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate grouping circuitry to generate a match panel by matching panelists with database proprietor accounts based on matching information, and generate respondent-level data from the match panel by combining first media exposure data corresponding to panelists associated with the match panel and second media exposure data corresponding to the database proprietor accounts associated with the match panel, the first and second media exposure data corresponding to a media item, and calculation circuitry to determine a probability distribution corresponding to observed deduplicated audience size data, the observed deduplicated audience size data based on the respondent-level data of the match panel, perform iterative proportional fitting on an output probability corresponding to the probability distribution, and determine a deduplicated total audience size for the media item based on a result of the iterative proportional fitting.

From the foregoing, it will be appreciated that example systems, methods, apparatus, and articles of manufacture have been disclosed that deduplicate audiences across media platforms. Disclosed systems, methods, apparatus, and articles of manufacture improve the efficiency of using a computing device by increase the accuracy of computations performed by the computing device when determining deduplicated audience sizes across different demographics. Accordingly, examples disclosed herein decrease errors in data calculated by computing devices, thereby, improving computational accuracies of computing devices. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
memory;
instructions in the apparatus; and
processor circuitry to execute the instructions to:
generate a match panel by matching panelists with database proprietor accounts based on matching information;
generate respondent-level data from the match panel by combining first media exposure data corresponding to panelists associated with the match panel and second media exposure data corresponding to the database proprietor accounts associated with the match panel, the first and second media exposure data corresponding to a media item;
determine a probability distribution corresponding to observed deduplicated audience size data, the observed deduplicated audience size data based on the respondent-level data of the match panel;
perform iterative proportional fitting on an output probability corresponding to the probability distribution; and
determine a deduplicated total audience size for the media item based on a result of the iterative proportional fitting.

2. The apparatus of claim 1, wherein the processor circuitry is to sample the probability distribution to generate the output probability.

3. The apparatus of claim 2, wherein the processor circuitry is to sample the probability distribution using a Hamilton Monte Carlo technique.

4. The apparatus of claim 1, wherein the processor circuitry is to perform the iterative proportional fitting to adjust the output probability according to information related at least one of a first reach corresponding to the panelists or a second reach corresponding to database proprietor impressions.

5. The apparatus of claim 1, wherein the deduplicated audience total corresponds to a reach across platforms, the platforms corresponding to at least one of television, desktop, or mobile.

6. The apparatus of claim 1, wherein the first media exposure data corresponds to television media and the second media exposure data corresponds to at least one of desktop media or mobile media.

7. The apparatus of claim 1, wherein the processor circuitry is to add a value to the output probability before performing the iterative proportional fitting to prevent an error during the iterative proportional fitting.

8. The apparatus of claim 1, wherein the processor circuitry is to cap the result of the iterative proportional fitting for statistical consistency.

9. The apparatus of claim 1, wherein the processor circuitry is to output a report based on the deduplicated total audience size.

10. The apparatus of claim 1, wherein the processor circuitry is to filter out a panelist from the match panel based on an in-tab percentage of the panelist.

11. The apparatus of claim 1, wherein the processor circuitry is to weight panelists of the match panel to represent a universe estimate.

12. The apparatus of claim 1, wherein the processor circuitry is to the match panel by:
matching the panelists to the database proprietor accounts based on combinations of matching information;
determining ranks of the matches based on corresponding ones of the combinations of matching information; and
generating the match panel based on the ranks.

13. A non-transitory computer readable medium comprising instructions which, when executed, cause one or more processors to at least:
generate a match panel by matching panelists with database proprietor accounts based on matching information;
generate respondent-level data from the match panel by combining first media exposure data corresponding to panelists associated with the match panel and second media exposure data corresponding to the database proprietor accounts associated with the match panel, the first and second media exposure data corresponding to a media item;
determine a probability distribution corresponding to observed deduplicated audience size data, the observed deduplicated audience size data based on the respondent-level data of the match panel;
perform iterative proportional fitting on an output probability corresponding to the probability distribution; and
determine a deduplicated total audience size for the media item based on a result of the iterative proportional fitting.

14. The computer readable storage medium of claim 13, wherein the instructions cause the one or more processors to sample the probability distribution to generate the output probability.

15. The computer readable storage medium of claim 14, wherein the instructions cause the one or more processors to sample the probability distribution using a Hamilton Monte Carlo technique.

16. The computer readable storage medium of claim 13, wherein the instructions cause the one or more processors to perform the iterative proportional fitting to adjust the output probability according to information related at least one of a first reach corresponding to the panelists or a second reach corresponding to database proprietor impressions.

17. The computer readable storage medium of claim 13, wherein the deduplicated audience total corresponds to a reach across platforms, the platforms corresponding to at least one of television, desktop, or mobile.

18. The computer readable storage medium of claim 13, wherein the first media exposure data corresponds to television media and the second media exposure data corresponds to at least one of desktop media or mobile media.

19. The computer readable storage medium of claim 13, wherein the instructions cause the one or more processors to add a value to the output probability before performing the iterative proportional fitting to prevent an error during the iterative proportional fitting.

20. An apparatus comprising:
processor circuitry including one or more of:
at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations, or the third operations to instantiate:
grouping circuitry to:
generate a match panel by matching panelists with database proprietor accounts based on matching information; and
generate respondent-level data from the match panel by combining first media exposure data corresponding to panelists associated with the match panel and second media exposure data corresponding to the database proprietor accounts associated with the match panel, the first and second media exposure data corresponding to a media item; and
calculation circuitry to:
determine a probability distribution corresponding to observed deduplicated audience size data, the observed deduplicated audience size data based on the respondent-level data of the match panel;
perform iterative proportional fitting on an output probability corresponding to the probability distribution; and
determine a deduplicated total audience size for the media item based on a result of the iterative proportional fitting.
